(19) United States
(12) Patent Application Publication
(10) Pub. No.: US 2025/0158335 A1
(43) Pub. Date: May 15, 2025

(54) CONNECTOR AND WAFER ASSEMBLY

(71) Applicant: Molex, LLC, Lisle, IL (US)

(72) Inventors: Jerry Dean Kachlic, Warrenville, IL (US); YongQi Zhao, Chengdu (CN); Jian Chen, Chengdu (CN); Wan Ho Foo, Singapore (SG); Shaunak Mahajani, Lisle, IL (US)

(21) Appl. No.: 18/923,716

(22) Filed: Oct. 23, 2024

(30) Foreign Application Priority Data
Nov. 10, 2023 (CN) 202311500605.2
Apr. 3, 2024 (CN) 202410400429.3

(51) Int. Cl. H01R 13/6587; H01R 13/514; H01R 13/6471

(52) U.S. Cl. CPC H01R 13/6587; H01R 13/514; H01R 13/6471

(57) ABSTRACT

A connector and a wafer assembly are described. A connector includes a housing and a wafer assembly. The wafer assembly includes a terminal row, a wafer mold insert, and a ground path assembly. The terminal row includes a plurality of terminal conductors, the ground path assembly includes a ground shield, and contact surface regions of the ground shield are terminated to surface regions of ground terminals among the plurality of terminal conductors in the wafer assembly. In one example, contact surface regions of the ground shield are laser welded to surfaces of the ground terminals. Shield extension regions of the ground shield also extend over signal terminals in the wafer assembly. The ground path assembly can also include both rigid and flexible shields in some cases. The grounding structure and ground path assembly facilitates higher data rate applications for the connector.

### TECHNICAL FIELD

The present disclosure relates to a connector with enhanced shielding and further relates to a wafer assembly.

### BACKGROUND

A range of input/output (I/O) connectors are designed for power, data, and power and data interconnect systems, including board-to-board, wire-to-wire, and wire-to-board systems. A variety of designs exist for each type of system, depending on the requirements of the power and data communications environment in which the connectors are used. As one example, a wire-to-board system includes a free-end connector attached to a wire and a fixed-end connector attached to a board.

For high data rate applications in which physical space is constrained, as one example, it can be challenging to design interconnection system connectors, due to a number of competing concerns. High data rate interconnection systems often rely upon differentially coupled signal pairs in which two conductors are arranged in a pair to transmit a differential signal. The signal being transmitted is embodied by the electrical difference measured between the conductor pair. Differential signaling can be helpful to avoid spurious signals and crosstalk and avoid inadvertent signaling modes among adjacent signal pairs. In connector interfaces, ground terminals can be relied upon to create a return path to electrical ground, provide shielding between differential pairs, and for other purposes.

Connectors used in high data rate applications are typically designed to meet a range of mechanical and electrical requirements. High data rate connectors are often used in backplane applications, as one example, that require very high conductor density and data rates. To achieve the desired mechanical and electrical requirements, the connectors used in such applications often incorporate one or more wafer assemblies. The wafer assemblies can include an insulative web that supports the terminal conductors in the wafer assemblies. The use of wafer assemblies can be helpful to manufacture connectors capable of achieving high data rates using a number of different assembly processes. It is still challenging, in any case, to design wafers having the conductor density and small footprint needed for high data rate applications in new systems, while also maintaining the desired electrical characteristics for the transmission of data with integrity.

### SUMMARY

Aspects of a connector with enhanced shielding are described herein. An example connector includes a housing and a wafer assembly. The wafer assembly includes a terminal row, a wafer mold insert, and a ground path assembly. The terminal row includes a plurality of terminal conductors, the ground path assembly includes a ground shield, and contact surface regions of the ground shield are terminated to surface regions of ground terminals among the plurality of terminal conductors in the wafer assembly. In one example, contact surface regions of the ground shield are laser welded to surfaces of the ground terminals. Shield extension regions of the ground shield also extend over signal terminals in the wafer assembly. The ground path assembly can also include both rigid and flexible shields in some cases. The grounding structure and ground path assembly facilitates higher data rate applications for the connector.

In other aspects of the embodiment, the ground shield includes a plurality of segments and bends between the plurality of segments, and contact surface regions of each of the plurality of segments of the ground shield are terminated to respective surface regions of the ground terminals in the wafer assembly. In other aspects, contact surface regions of a rigid ground shield are terminated to lower surface regions of ground terminals in the wafer assembly and contact surface regions of flexible ground shield are terminated to upper surface regions of the ground terminals.

In other examples, the wafer mold insert includes an interlock flange and the housing includes a latch finger formed in a side of the housing. When the wafer assembly is inserted into the housing, the latch finger of the housing snaps into a position of mechanical interference with the interlock flange of the wafer mold insert. In other cases, the wafer mold insert includes an interlock leg and the housing includes a leg latch finger formed in a bottom of the housing. When the wafer assembly is inserted into the housing, the leg latch finger of the housing snaps into a position of mechanical interference with the interlock leg of the wafer mold insert. In still other cases, the wafer mold insert includes an interlock flange and the housing includes a wafer datum channel and a latch finger formed in a side of the housing. When the wafer assembly is inserted into the housing, the interlock flange of the wafer mold insert slides into the wafer datum channel of the housing and the latch finger of the housing snaps into a position of mechanical interference with the interlock flange of the wafer mold insert.

In other aspects, the connector also includes a second wafer assembly. The second wafer assembly includes a second terminal row, a second wafer mold insert, and a second ground path assembly. The second wafer mold insert includes a positioning socket, the wafer mold insert includes a positioning post, and the positioning post of the wafer assembly extends within the positioning socket of the second wafer assembly. The ground shield of the wafer assembly can extend between the terminal row of the wafer assembly and the second terminal row of the second wafer assembly.

An example wafer assembly includes a terminal row, a wafer mold insert, and a ground path assembly. The terminal row includes a plurality of terminal conductors. The ground path assembly includes a rigid ground shield and a flexible ground shield. Contact surface regions of the rigid ground shield are terminated to first surface regions of ground terminals among the plurality of terminal conductors in the wafer assembly, and contact surface regions of the flexible ground shield are terminated to second surface regions of the ground terminals in the wafer assembly. In other aspects, shield extension regions of the rigid ground shield extend over signal terminals among the plurality of terminal conductors in the wafer assembly, and shield extension regions of the flexible ground shield extend over the signal terminals in the wafer assembly. In other aspects, the contact surface regions of the rigid ground shield are terminated to lower surface regions of the ground terminals in the wafer assembly, and the contact surface regions of the flexible ground shield are terminated to upper surface regions of the ground terminals in the wafer assembly.

Another example connector includes a housing, a first wafer assembly including a first terminal row, a first wafer mold insert, and a first ground path assembly, and a second wafer assembly including a second terminal row, a second wafer mold insert, and a second ground path assembly. The first ground path assembly includes a first ground shield, and the second ground path assembly includes a second ground shield. Contact surface regions of the first ground shield are terminated to first surface regions of ground terminals among of the first terminal row in the first wafer assembly, and contact surface regions of the second ground shield are terminated to second surface regions of ground terminals among of the second terminal row in the second wafer assembly.

In other aspects, the first wafer mold insert includes a first interlock flange, and the second wafer mold insert includes a second interlock flange. The housing also includes a first latch finger and a second latch finger formed in a side of the housing. When the first wafer assembly and the second wafer assembly are inserted into the housing, the first latch finger of the housing snaps into a position of mechanical interference with the first interlock flange and the second latch finger of the housing snaps into a position of mechanical interference with the second interlock flange. In other aspects, the second wafer mold insert includes a positioning socket, the first wafer mold insert includes a positioning post, and the positioning post extends within the positioning socket to align the first wafer assembly with the second wafer assembly.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A illustrates a top-down perspective view of an example connector according to various embodiments of the present disclosure.

FIG. 1B illustrates a bottom-up perspective view of the connector shown in FIG. 1A according to various embodiments of the present disclosure.

FIG. 1C illustrates a front view of the connector shown in FIG. 1A according to various embodiments of the present disclosure.

FIG. 1D illustrates the sectional view of the housing of the connector designated A-A in FIG. 1A according to various embodiments of the present disclosure.

FIG. 2A illustrates a top-down perspective view of example wafer assemblies of the connector shown in FIG. 1A according to various embodiments of the present disclosure.

FIG. 2B illustrates a bottom-up perspective view of the wafer assemblies shown in FIG. 2A according to various embodiments of the present disclosure.

FIG. 2C illustrates a side view of the wafer assemblies shown in in FIG. 2A according to various embodiments of the present disclosure.

FIG. 3A illustrates a top-down perspective view of the wafer assemblies of the connector shown in FIG. 2A according to various embodiments of the present disclosure.

FIG. 3B illustrates a top-down perspective view of the wafer assemblies of the connector shown in FIG. 2A according to various embodiments of the present disclosure.

FIG. 3C illustrates a bottom-up perspective view of the wafer assemblies shown in FIG. 3B according to various embodiments of the present disclosure.

FIG. 4A illustrates a partly exploded view of a wafer assembly of the connector shown in FIG. 1A according to various embodiments of the present disclosure.

FIG. 4B illustrates a partly exploded view of another wafer assembly of the connector shown in FIG. 1A according to various embodiments of the present disclosure.

FIG. 4C illustrates a partly exploded view of another wafer assembly of the connector shown in FIG. 1A according to various embodiments of the present disclosure.

FIG. 4D illustrates a partly exploded view of another wafer assembly of the connector shown in FIG. 1A according to various embodiments of the present disclosure.

FIG. 5 illustrates the sectional view of the connector designated B-B in FIG. 1D according to various embodiments of the present disclosure.

FIG. 6 illustrates a top-down perspective view of an example connector according to yet another embodiment of the present disclosure.

FIG. 7 illustrates a bottom-up perspective view of the connector shown in FIG. 6 according to the yet another embodiment of the present disclosure.

FIG. 8 illustrates a top-down exploded perspective view of a housing of the connector according to the yet another embodiment of the present disclosure.

FIG. 9 illustrates a bottom-up exploded perspective view of the housing of the connector according to the yet another embodiment of the present disclosure.

FIG. 10 and FIG. 11 respectively illustrate perspective views of an interior structure of the housing of the connector according to the yet another embodiment of the present disclosure from different angles.

FIG. 12 and FIG. 13 respectively illustrate a top-down exploded perspective view and a bottom-up exploded perspective view of wafer assemblies of the connector according to the yet another embodiment of the present disclosure.

FIG. 14 and FIG. 15 respectively illustrate a perspective view and a sectional schematic view of a first wafer assembly, a second wafer assembly, a third wafer assembly and a fourth wafer assembly assembled together according to the connector of the yet another embodiment of the present disclosure.

FIG. 16A illustrates an entire bottom-up schematic view of the connector according to the yet another embodiment of the present disclosure.

FIG. 16B illustrates a sectional view of the connector designated A-A in FIG. 16A according to the yet another embodiment of the present disclosure.

FIG. 17 illustrates a schematic view of a flexible shield of another embodiment.

### DETAILED DESCRIPTION

Connectors are typically designed to meet a range of mechanical and electrical requirements. High data rate connectors are often used in backplane applications, as one example, that require very high conductor density and data rates. To achieve the desired mechanical and electrical requirements, the connectors used in such applications often incorporate one or more wafer assemblies. The wafer assemblies can include an insulative web that supports the terminal conductors in the wafer assemblies. The use of wafer assemblies can be helpful to manufacture connectors capable of high data rates using a range of different assembly processes. It is still challenging, in any case, to design wafers and connectors having the conductor density and small footprint needed for high data rate applications in new systems, while also maintaining the desired electrical characteristics for the transmission of data with integrity.

In the context outlined above, various aspects and embodiments of connectors with enhanced shielding are described herein. An example connector includes a housing and a wafer assembly. The wafer assembly includes a terminal row, a wafer mold insert, and a ground path assembly. The terminal row includes a plurality of terminal conductors, the ground path assembly includes a ground shield, and contact surface regions of the ground shield are terminated to surface regions of ground terminals among the plurality of terminal conductors in the wafer assembly. In one example, contact surface regions of the ground shield are laser welded to surfaces of the ground terminals. Shield extension regions of the ground shield also extend over signal terminals in the wafer assembly. The ground path assembly can also include both rigid and flexible ground shields in some cases. The grounding structure and ground path assembly facilitates higher data rate applications for the connector.

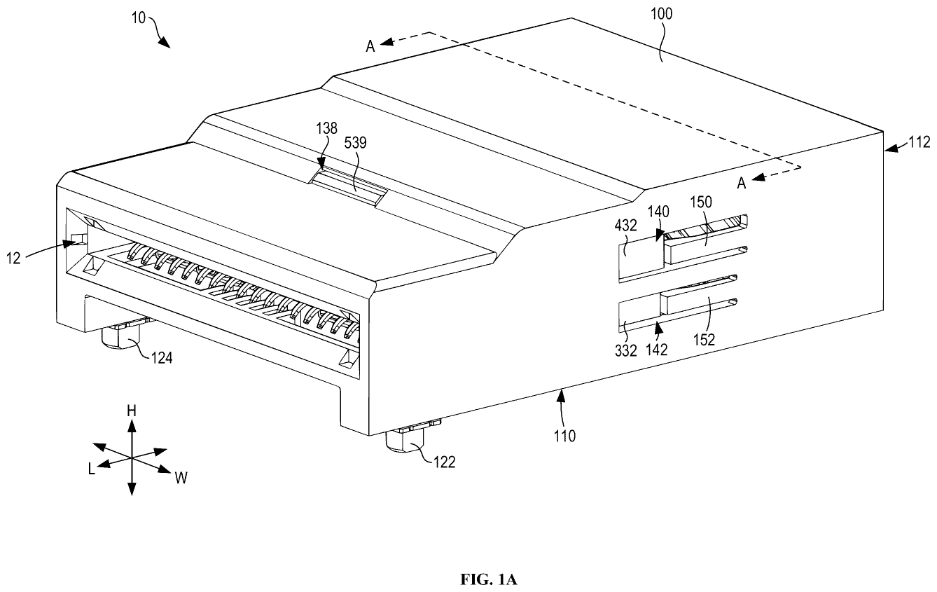

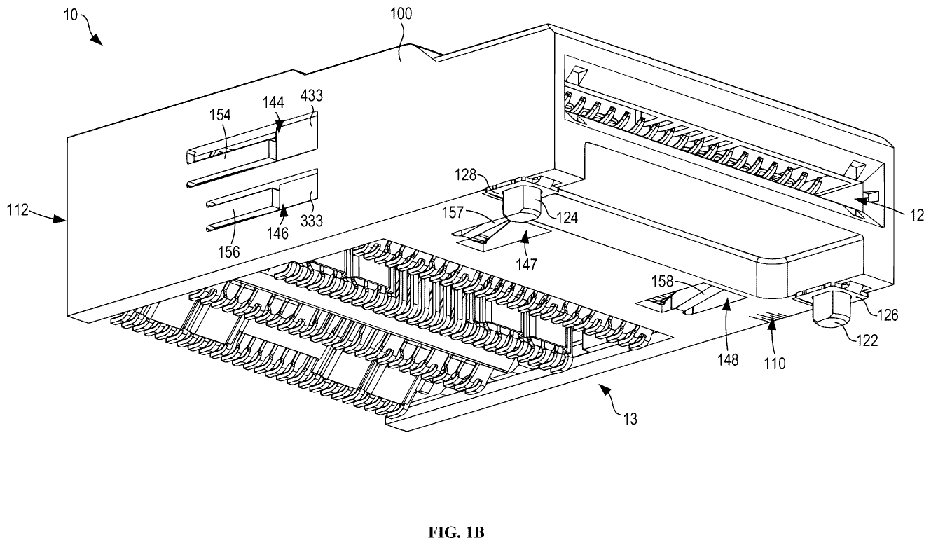

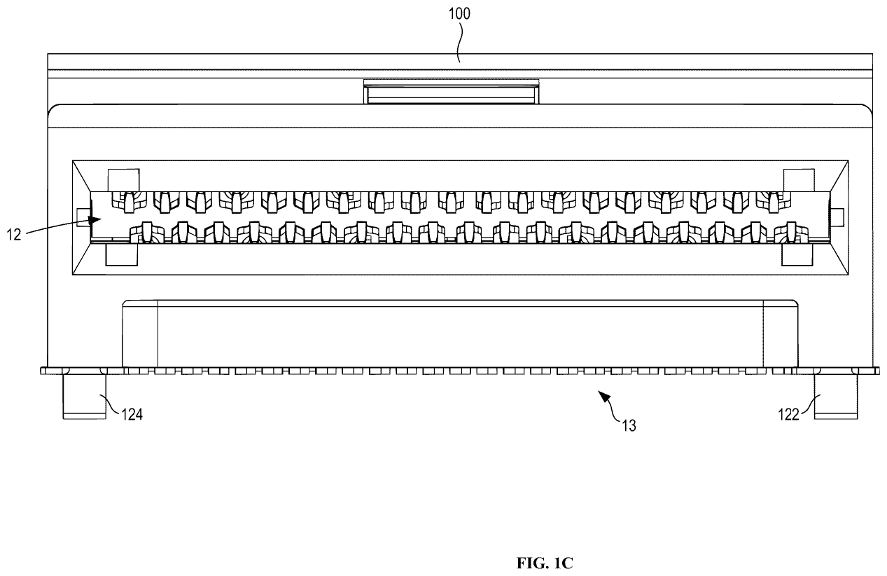

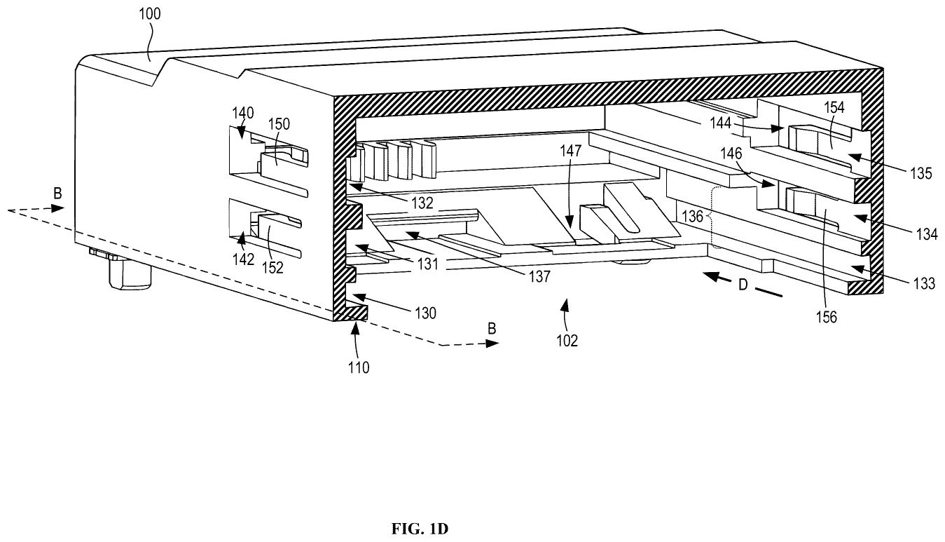

Turning to the drawings, FIG. 1A illustrates a perspective view of an example connector 10 (also “connector 10”) according to various embodiments of the present disclosure. FIG. 1B illustrates a bottom-up perspective view of the connector 10, and FIG. 1C illustrates a front view of the connector 10. The connector 10 is shown to have a length, a width, and a height in the directions shown in FIG. 1A. However, the connector 10 is illustrated as a representative example and is not drawn to any particular scale or size. The shape, size, proportion, and other characteristics of the connector 10 can vary as compared to that shown. For example, the connector 10 can accommodate larger or smaller rows of terminals (e.g., be wider or narrower), and other variations are within the scope of the examples described herein. A number of connectors similar to the connector 10 can be arranged side-by-side for higher data rate interconnections in some cases. Additionally, one or more of the parts or components of the connector 10, as illustrated in the drawings and described herein, can be omitted in some cases. The connector 10 can also include other parts or components that are not illustrated.

Referring among FIGS. 1A-1C, the connector 10 includes a front port opening 12 and a terminal foot 13. The connector 10 is designed to establish and maintain electrical connections with contacts on the free end interface of a cable assembly. For example, a printed circuit board (PCB)-style interface of a Small Form Factor Pluggable (SFP), Octal Small Form Factor Pluggable (OSFP), Quad Small Form Factor Pluggable (QSFP), or similar cable assembly can be inserted into the front port opening 12 of the connector 10.

The connector 10 includes terminal rows of terminal conductors that extend from the front port opening 12 to the terminal foot 13, for the communication of data signals on the terminal conductors. The connector 10 includes several structural features to maintain the alignment and position of the terminal conductors within the connector 10. The connector 10 is also designed to provide shielding and maintain the signal integrity of differential signals on the terminal conductors, as they extend from the front port opening 12 to the terminal foot 13. The connector 10 can be designed for use with SFP, OSFP, QSFP, and related interconnection systems, although the concepts described herein are not limited to use with any particular type or style of interconnect system. The terminal foot 13 of the connector 10 is designed as a Surface-Mount Technology (SMT) foot for coupling to contact pads on the surface of a printed circuit board (PCB), but the connector 10 can also be designed to have through-hole leads or other lead styles at the terminal foot 13 in some cases.

As shown in FIGS. 1A-1C, the connector 10 includes a housing 100. The housing 100 can be formed from a plastic or other insulating material, in one example, although the housing can also be formed from combinations of insulating and conductive materials in some cases. The housing 100 can be formed by any suitable additive or subtractive manufacturing techniques, such as molding, injection molding, printing, and other techniques. In some cases, outer surfaces or certain surface areas of the housing 100 can be plated with a plating metal or metals for conductivity, and the housing 100 can be embodied as a plated plastic component in some cases.

The housing 100 includes a bottom mounting surface 110, a back surface 112, mounting posts 122 and 124, solder rings 126 and 128, and other features described below. The connector 10 is adapted to receive the PCB-style tip of an SFP, OSFP, QSFP, or related connector module at the end of a cable assembly. The PCB-style tip of the cable assembly can fit into the front port opening 12 of the connector 10. When inserted, terminal rows of wafer assemblies within the housing 100 seat against and make electrical contact with contacts on the surfaces of the PCB-style tip.

The mounting posts 122 and 124 extend down from the bottom mounting surface 110 of the housing 100. The mounting posts 122 and 124 can be integrally formed from the same insulating material as the remainder of the housing 100 in one example. In other cases, however, the mounting posts 122 and 124 can be formed from a different material than the remainder of the housing 100, such as a conductive metal, and the remainder of the housing 100 can be molded around the mounting posts 122 and 124. The mounting posts 122 and 124 can be inserted through openings or apertures (e.g., mounting apertures, plated vias, etc.) in a PCB board upon which the housing 100 is surface mounted. The solder rings 126 and 128 can be formed (e.g., stamped, sheared, or otherwise formed) from a sheet of metal and plated in some cases. The mounting posts 122 and 124 extend through central apertures of the solder rings 126 and 128. The housing 100 can be molded around the solder rings 126 and 128, or the solder rings 126 and 128 can be inserted into the housing 100 after it is molded. In examples in which outer surfaces of the housing 100 are plated for conductivity, the solder rings 126 and 128 can be electrically coupled with the outer conductive surfaces of the housing 100.

FIG. 1D illustrates the sectional view of the housing 100 of the connector 10 designated A-A in FIG. 1A. As noted above, the connector 10 includes a number of wafer assemblies positioned within the housing 100. Those wafer assemblies are omitted from view in FIG. 1D to illustrate internal features within the housing 100. The housing includes an internal region 102 of space in which the wafer assemblies are positioned and secured when the connector 10 is assembled.

As shown in FIG. 1D, the housing 100 includes wafer datum channels 130-132 formed in one side of the housing 100 and wafer datum channels 133-135 formed in another, opposite side of the housing 100. The housing 100 also includes a wafer datum channel 136 in one side of the housing 100 and a similar wafer datum channel (not shown in FIG. 1D) in the opposite side of the housing 100. The wafer datum channels 130-136 (also “channels 130-136”) are formed as recessed channels in the sides of the housing 100 within the internal region 102 of the housing 100. The channels 130-136 extend from the back surface 112 towards the front port opening 12 within the internal region 102 of the housing 100. The length, width, and depth of the channels 130-136 can vary among the embodiments. The direction of the channels 130-136 can also vary in some cases as compared to that shown. The channels 130-136 are formed to cooperate with the guide flanges and the interlock flanges of the wafer assemblies of the connector 10, to position and secure the wafer assemblies in place within the internal region 102 of the housing 100, as described in further detail below.

The housing 100 also includes openings 140 and 142 (see FIG. 1A) through one side of the housing 100 and openings 144 and 146 (see FIG. 1B) through another, opposite side of the housing 100. The openings 140, 142, 144, and 146 extend from outside the housing 100 to the internal region 102 within the housing 100. The openings 140, 142, 144, and 146 extend from outside the housing 100 to the internal region 102 within the housing 100. A latch finger extends within each of the openings 140, 142, 144, and 146 in a cantilevered arrangement. Particularly, the latch fingers 150, 152, 154, and 156 extend in a cantilevered arrangement, respectively, from the side edge or wall of the openings 140, 142, 144, and 146. The latch fingers 150, 152, 154, and 156 are integrally formed with the housing 100 from the same material as the housing 100 in the example shown, although the latch fingers 150, 152, 154, and 156 can also be formed from other materials and arranged or assembled with the housing 100 in other ways.

Being cantilevered and formed from a relatively compliant (e.g., polymer) material, the latch fingers 150, 152, 154, and 156 can bend to some extent upon the application of forces against them. The latch fingers 150, 152, 154, and 156 are also elastic and will return to the position shown in FIGS. 1A and 1B when such forces are withdrawn. The latch fingers 150, 152, 154, and 156 are designed to mechanically interface and interfere with interlock flanges of the wafer assemblies of the connector 10, to secure the wafer assemblies in place within the internal region 102 of the housing 100, as described in further detail below.

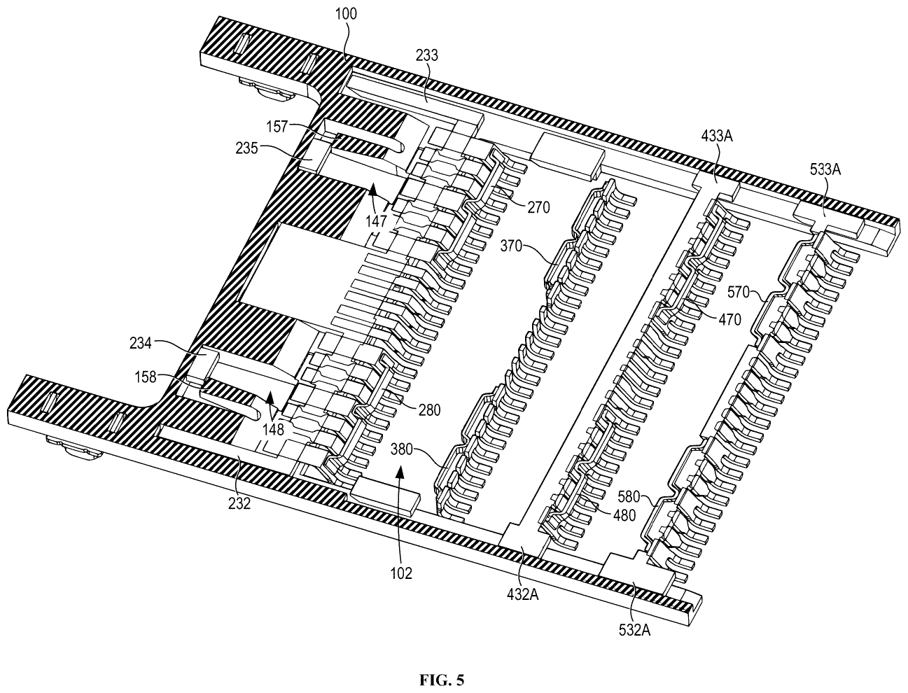

The housing 100 also includes openings 147 and 148 (see FIG. 1C) through the bottom of the housing 100. The openings 147 and 148 extend from outside the housing 100 to the internal region 102 within the housing 100. A leg latch finger extends within each of the openings 147 and 148 in a cantilevered arrangement. Particularly, the leg latch fingers 157 and 158 extend in a cantilevered arrangement, respectively, from around a periphery of the openings 147 and 148. The leg latch fingers 157 and 158 are integrally formed with the housing 100 from the same material as the housing 100 in the example shown, although the leg latch fingers 157 and 158 can also be formed from other materials and arranged or assembled with the housing 100 in other ways. The leg latch fingers 157 and 158 mechanically cooperate and interfere with interlock legs of a wafer assembly within the housing 100, to maintain and secure the wafer assembly in place, as described in further detail below with reference to FIG. 5.

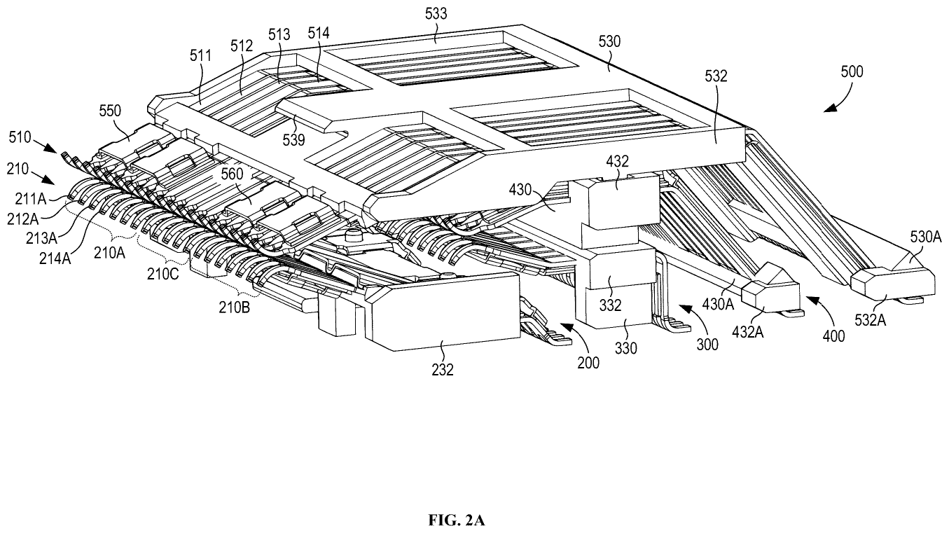

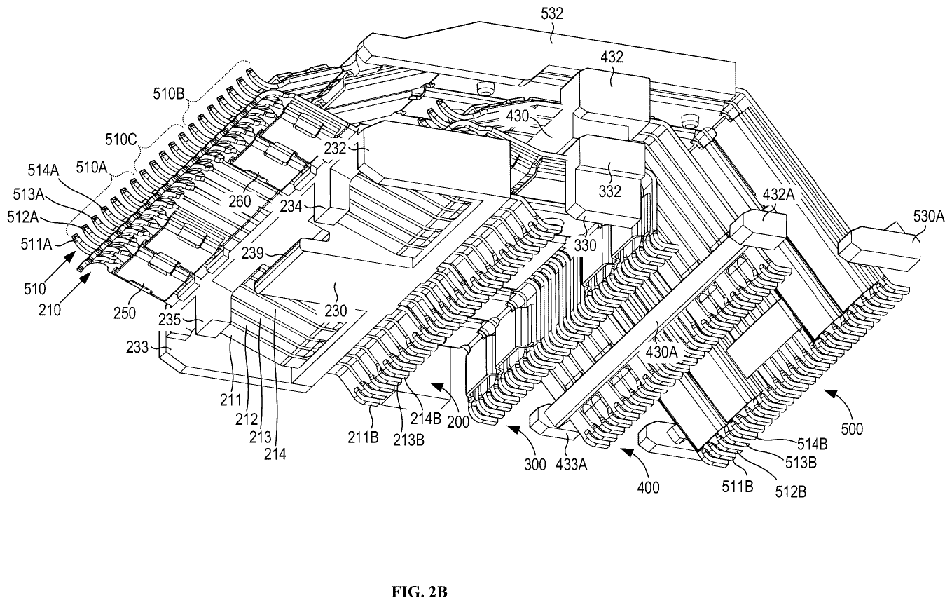

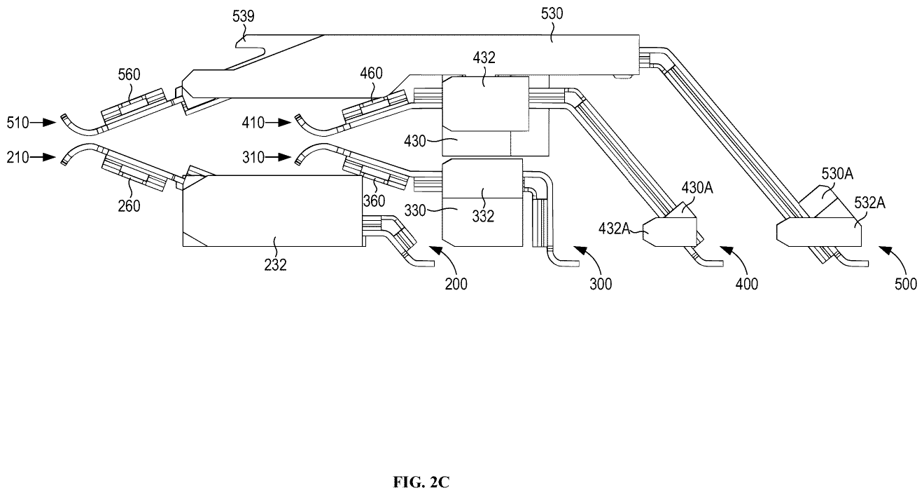

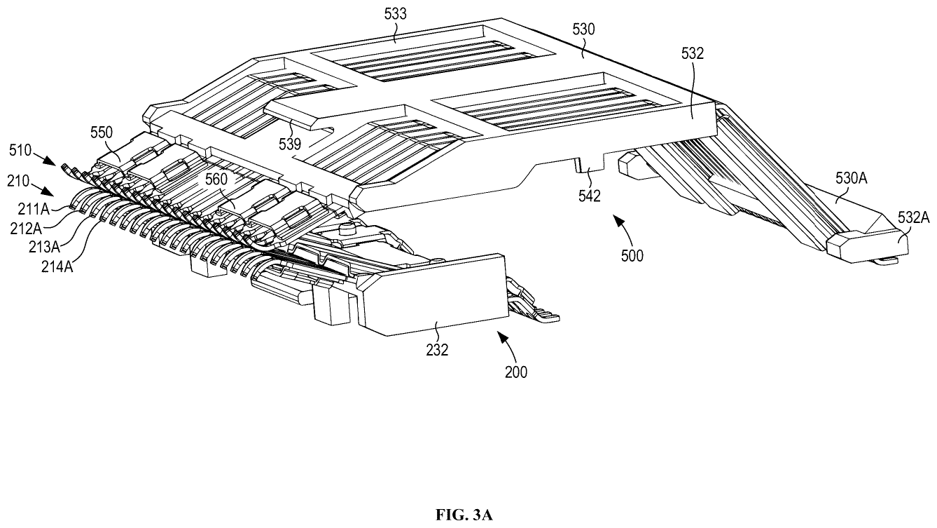

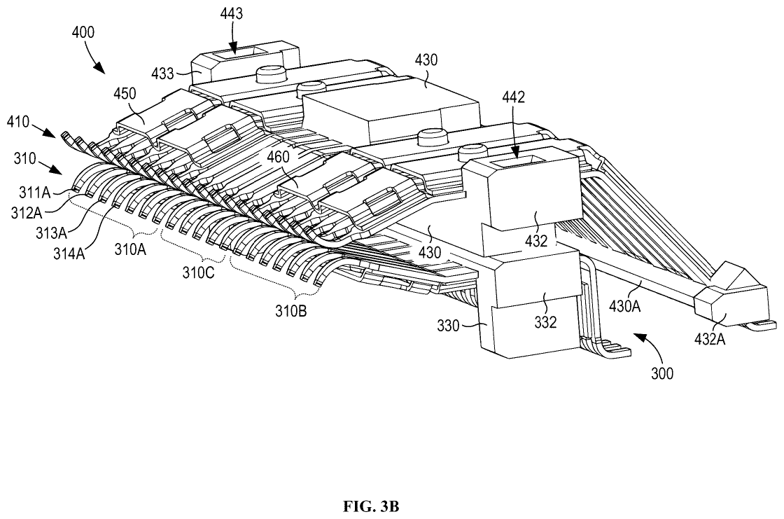

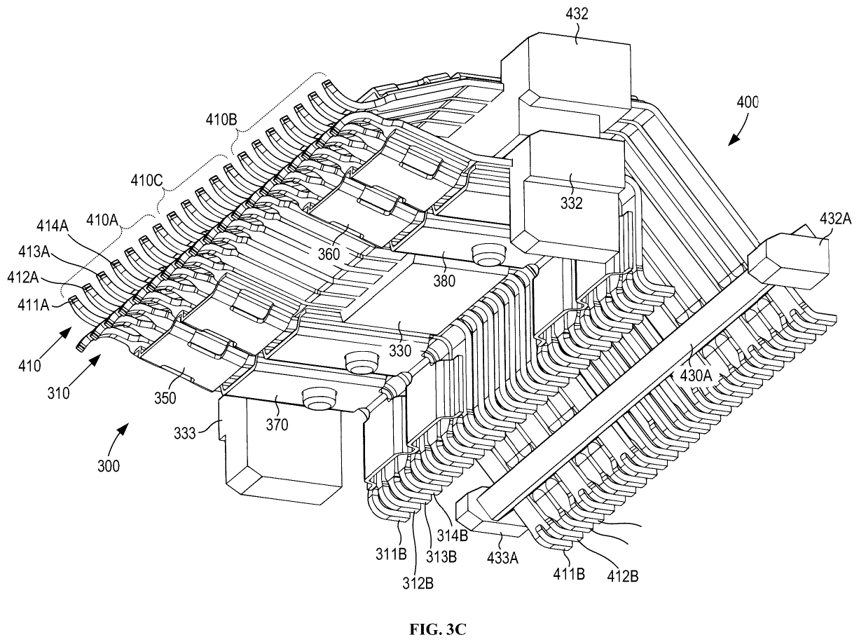

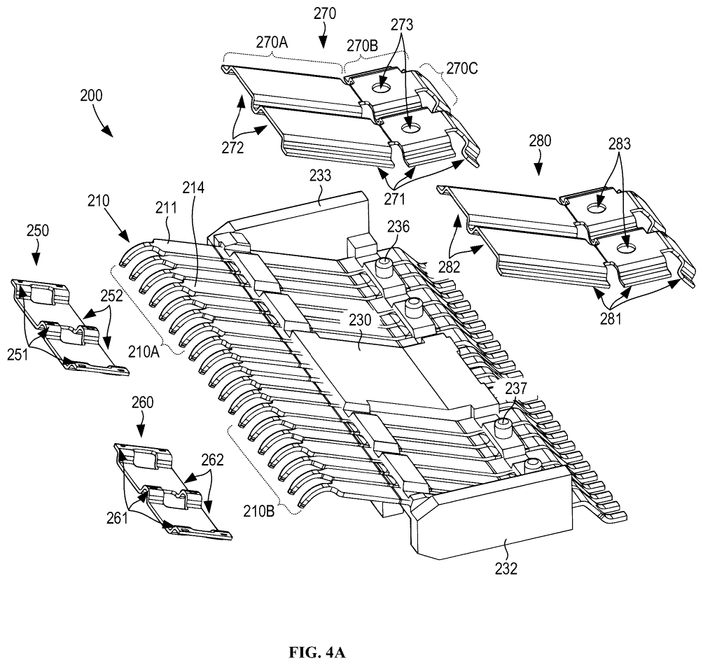

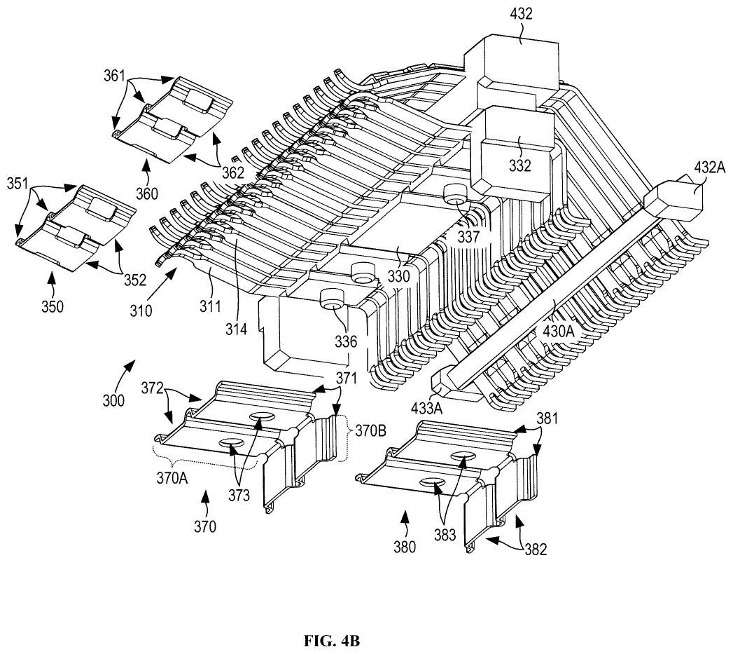

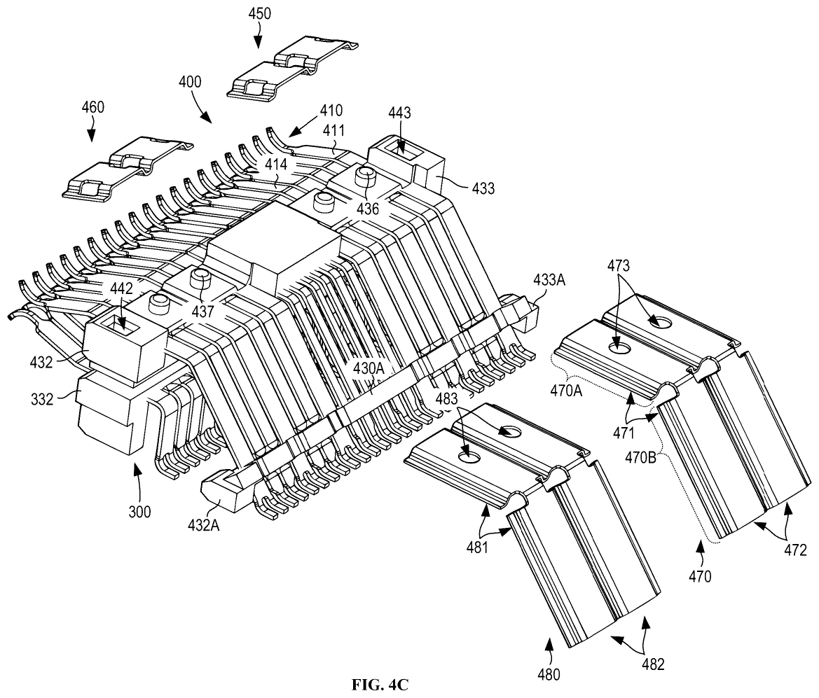

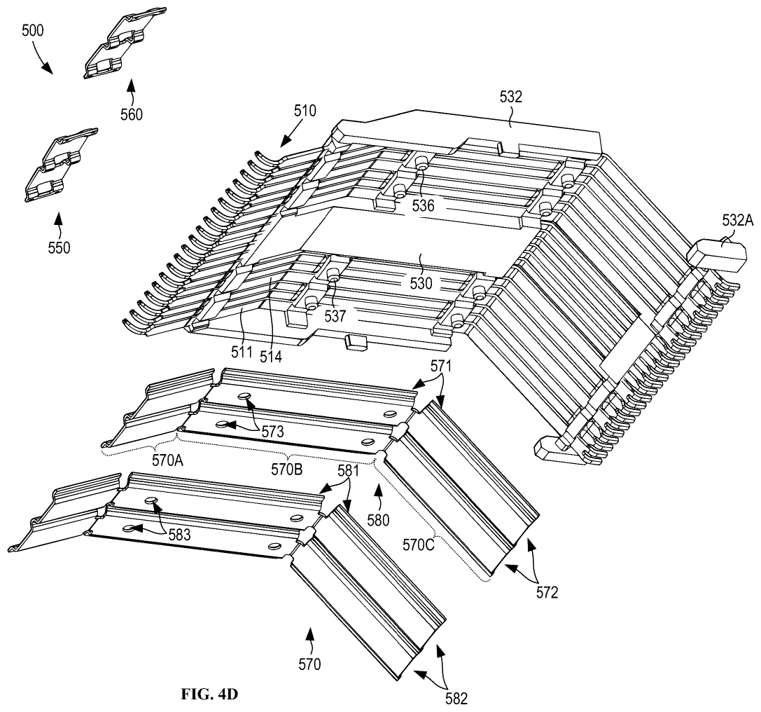

FIG. 2A illustrates a top-down perspective view of example wafer assemblies 200, 300, 400, and 500 of the connector 10 shown in FIG. 1A, with the housing 100 omitted from view. FIG. 2B illustrates a bottom-up perspective view of the wafer assemblies 200, 300, 400, and 500, and FIG. 2C illustrates a side view of the wafer assemblies 200, 300, 400, and 500. The wafer assemblies 200, 300, 400, and 500 are illustrated as representative examples and are not drawn to any particular scale or size. FIG. 3A illustrates a top-down perspective view of the wafer assemblies 200 and 500 of the connector 10 shown in FIG. 2A. FIG. 3B illustrates a top-down perspective view of the wafer assemblies 300 and 400, and FIG. 3C illustrates a bottom-up perspective view of the wafer assemblies 300 and 400. The shape, size, proportion, and other characteristics of the wafer assemblies 200, 300, 400, and 500 can vary as compared to that shown. For example, the wafer assemblies 200, 300, 400, and 500 can accommodate larger or smaller rows of terminals (e.g., be wider or narrower), and other variations are within the scope of the examples described herein. Additionally, one or more of the parts or components of the wafer assemblies 200, 300, 400, and 500, as illustrated in the drawings and described herein, can be omitted in some cases. The wafer assemblies 200, 300, 400, and 500 can also include other parts or components that are not illustrated. The wafer assemblies 200, 300, 400, and 500 of the connector 10 are introduced below with reference to FIGS. 2A-2C and 3A-3C, and detail views of the wafer assemblies 200, 300, 400, and 500 are then described with reference to FIGS. 4A-4D.

Referring among FIGS. 2A-2C and 3A-3C, the wafer assembly 200 includes the terminal row 210, a wafer mold insert 230, and other components described below. The wafer assembly 200 supports, spaces, and aligns terminal conductors in the terminal row 210. The wafer assembly 300 includes the terminal row 310, a wafer mold insert 330, and other components described below. The wafer assembly 300 supports, spaces, and aligns terminal conductors in the terminal row 310. The wafer assembly 400 includes the terminal row 410, a wafer mold insert 430, a wafer mold insert 430A, and other components described below. The wafer assembly 400 supports, spaces, and aligns terminal conductors in the terminal row 410. The wafer assembly 500 includes the terminal row 510, a wafer mold insert 530, a wafer mold insert 530A, and other components described below. The wafer assembly 500 supports, spaces, and aligns terminal conductors in the terminal row 410. Each of the wafer assemblies 200, 300, 400, and 500 also includes a ground path assembly including one or more shields. The ground path assemblies of the wafer assemblies 200, 300, 400, and 500 are described in further detail below.

Each of the terminal rows 210, 310, 410, and 510 includes a row of terminal conductors, including signal conductors, power conductors, and ground conductors. The signal and power conductors in the terminal rows 210, 310, 410, and 510 each includes a lead contact at one distal end (i.e., positioned within the front port opening 12 of the connector 10 shown in FIG. 1), a tail contact at another distal end (i.e., positioned at the terminal foot 13), and one or more conductor bends between the lead contact and the tail contact. The signal and power conductors in the terminal rows 210, 310, 410, and 510 are electrically isolated from each other within the connector 10. The signal and power conductors extend, starting from the lead contacts at the front port opening 12, to the tail contacts at the terminal foot 13 of the connector 10. The tail contacts of the signal and power conductors can be formed as SMT tail contacts, as in the example shown, or through-hole or other types of contacts. The ground conductors in the terminal rows 210, 310, 410, and 510 each include a lead contact at one distal end and a tail contact at another distal end. The ground conductors extend from lead contacts within the front port opening 12 to tail contacts at the terminal foot 13 of the connector 10.

Referring between FIGS. 2A and 2B, the terminal row 210 includes a first group 210A of terminal conductors, a second group 210B of terminal conductors, and a central group 210C of terminal conductors between the first group 210A and the second group 210B. The groups 210A and 210B include ground and signal conductors. For example, the group 210A includes a ground conductor 211, a differential pair of signal conductors 212 and 213, and a ground conductor 214. The conductors 211-214 include lead contacts 211A-214A, respectively, which are positioned at the front port opening 12 of the connector 10, and tail contacts 211B-214B, respectively, which are positioned at the terminal foot 13 of the connector 10. The conductors 211 and 214 are ground conductors in the terminal row 210, and the conductors 212 and 213 are signal conductors in the terminal row 210. The signal conductors 212 and 213 are positioned between the ground conductors 211 and 214, as shown. Each terminal conductor in the terminal row 210 includes conductor bends between the lead contact and the tail contact.

Referring between FIGS. 3B and 3C, the terminal row 310 includes a first group 310A of terminal conductors, a second group 310B of terminal conductors, and a central group 310C of terminal conductors between the first group 310A and the second group 310B. The groups 310A and 310B include ground and signal conductors. For example, as also referenced in FIG. 5B, the group 310A includes a ground conductor 311, a differential pair of signal conductors 312 and 313, and a ground conductor 314. The conductors 311-314 include lead contacts 311A-314A, respectively, which are positioned at the front port opening 12 of the connector 10, and tail contacts 311B-314B, respectively, which are positioned at the terminal foot 13 of the connector 10. The conductors 311 and 314 are ground conductors in the terminal row 310, and the conductors 312 and 313 are signal conductors in the terminal row 310. The signal conductors 312 and 313 are positioned between the ground conductors 311 and 314, as shown. Each terminal conductor in the terminal row 310 includes conductor bends between the lead contact and the tail contact.

Referring between FIGS. 3B and 3C, the terminal row 410 includes a first group 410A of terminal conductors, a second group 410B of terminal conductors, and a central group 410C of terminal conductors between the first group 410A and the second group 410B. The groups 410A and 410B include ground and signal conductors. For example, as also referenced in FIG. 5A, the group 410A includes a ground conductor 411, a differential pair of signal conductors 412 and 413, and a ground conductor 414. The conductors 411-414 include lead contacts 411A-414A, respectively, which are positioned at the front port opening 12 of the connector 10, and tail contacts 411B-414B, respectively, which are positioned at the terminal foot 13 of the connector 10. The conductors 411 and 414 are ground conductors in the terminal row 410, and the conductors 412 and 413 are signal conductors in the terminal row 410. The signal conductors 412 and 413 are positioned between the ground conductors 411 and 414, as shown. Each terminal conductor in the terminal row 410 includes conductor bends between the lead contact and the tail contact.

Referring between FIGS. 2A and 2B, the terminal row 510 includes a first group 510A of terminal conductors, a second group 510B of terminal conductors, and a central group 510C of terminal conductors between the first group 510A and the second group 510B. The groups 510A and 510B include ground and signal conductors. For example, the group 510A includes a ground conductor 511, a differential pair of signal conductors 512 and 513, and a ground conductor 514. The conductors 511-514 include lead contacts 511A-514A, respectively, which are positioned at the front port opening 12 of the connector 10, and tail contacts 511B-514B, respectively, which are positioned at the terminal foot 13 of the connector 10. The conductors 511 and 514 are ground conductors in the terminal row 510, and the conductors 512 and 513 are signal conductors in the terminal row 510. The signal conductors 512 and 513 are positioned between the ground conductors 511 and 514, as shown. Each terminal conductor in the terminal row 510 includes conductor bends between the lead contact and the tail contact.

The group 210A of the terminal row 210 includes four signal conductors and three ground conductors, for a total of seven terminal conductors, with each pair of the signal conductors being positioned side-by-side between two ground conductors. The central group 210C of terminal conductors includes power conductors and, in some cases, can include ground or signal conductors. The group 210B is similar to the group 210A but is positioned on another side of the central group 210C. As compared to the terminal row 210, each of the terminal rows 310, 410, and 510 includes a similar arrangement of signal, ground, and power conductors. However, the individual lengths, bend shapes, and other characteristics of the terminal conductors in the terminal rows 210, 310, 410, and 510 can differ as compared to each other.

The lead contacts of the terminal row 210 face the lead contacts of the terminal row 510. The lead contacts of the terminal row 310 face the lead contacts of the terminal row 410. The pitch between the lead contacts is the same in each of the terminal rows 210, 310, 410, and 510 in one example. However, the terminal conductors in the terminal row 210 may be offset from those in the terminal row 510, such that the lead contacts are offset between the rows. The terminal conductors in the terminal row 310 may also be offset from those in the terminal row 410, such that the lead contacts are offset between the rows. In other cases, the terminal conductors in the terminal rows 210 and 510 may have the same pitch and be aligned (i.e., not staggered) with respect to each other. In still other cases, the terminal conductors in the terminal rows 210 and 510 may have different lead contact pitches as compared to each other. Similarly, the terminal conductors in the terminal rows 310 and 410 may have the same pitch and be aligned with respect to each other, or the terminal rows 310 and 410 may have different lead contact pitches as compared to each other.

The wafer mold insert 230 of the wafer assembly 200 can be formed from a plastic, such as liquid crystal polymer (LCP), polyethylene (PE), polytetrafluoroethylene (PTFE), fluoropolymer, or other plastic or insulating material(s) and is molded around the terminal conductors in the terminal row 210. For example, a leadframe including the terminal row 210 can be formed (e.g., stamped, sheared, or otherwise formed) from a flat sheet of metal to form a leadframe. In some cases, the flat sheet of metal can be plated with one or more plating metals. The leadframe and the terminal row 210 can be pressed or bent into the shape of the terminal row 210. The leadframe including the terminal row 210 can then be placed into a mold, and a plastic material can be injected into the mold to form the wafer mold insert 230 around the terminal row 210. The terminal row 210 can then be sheared or cut away from the leadframe, and the individual terminal conductors of the terminal row 210 can then be further bent or otherwise formed to the shape as illustrated.

The wafer mold insert 230 of the wafer assembly 200 maintains the separation between and supports the terminal conductors in the terminal row 210. The wafer mold insert 230 also includes structural features for positioning and securing the wafer assembly 200 within the housing 100 of the connector 10. More particularly, the wafer mold insert 230 includes guide flanges 232 and 233 for guiding the wafer assembly 200 within the housing 100 during assembly of the connector 10, as described in further detail below. The guide flanges 232 and 233 are formed to be rectangular cuboids in shape in the example shown and include chamfered corners or edges at the front side, although the size and shape of the guide flanges 232 and 233 can vary among the embodiments. The guide flange 233 is sized to fit and slide within the wafer datum channel 136 (see FIG. 1D) of the housing 100 with a minimal clearance, and the guide flange 232 is also sized to fit and slide within a similar wafer datum channel of the housing 100. During assembly of the connector 10, the wafer assembly 200 is positioned so that the guide flanges 232 and 233 are aligned with the wafer datum channels of the housing 100. The wafer assembly 200 can then be inserted into the internal region 102 of the housing 100 in the direction “D” shown in FIG. 1D, and the guide flanges 232 and 233 can slide within the wafer datum channels of the housing 100.

The wafer mold insert 230 also includes interlock legs 234 and 235 for positioning and securing the wafer assembly 200 within the housing 100 of the connector 10. The interlock legs 234 and 235 are formed to be rectangular cuboids in shape, although the size and shape of the interlock legs 234 and 235 can vary among the embodiments. The interlock legs 234 and 235 are designed to mechanically interface with the leg latch fingers 157 and 158 of the housing 100, as described in further detail below with reference to FIG. 5.

The wafer mold insert 230 also includes an interlock nose 239 for positioning the wafer assembly 200 within the housing 100 of the connector 10. The interlock nose 239 is positioned at a relative center of the wafer assembly 200 and is formed as an elongated nose. The interlock nose 239 fits and extends into a corresponding positioning recess 137 (see FIG. 1D) within the housing 100 when the connector 10 is assembled. That is, the interlock nose 239 fits within and occupies the positioning recess 137 with a minimal clearance between the outer surfaces of the interlock nose 239 and the inner surfaces of the positioning recess 137 within the housing 100 when the connector 10 is assembled.

The wafer mold insert 330 of the wafer assembly 300 can be formed from a plastic, such as LCP, PE, PTFE, fluoropolymer, or other plastic or insulating material(s) and is molded around the terminal conductors in the terminal row 310. For example, a leadframe including the terminal row 310 can be formed (e.g., stamped, sheared, or otherwise formed) from a flat sheet of metal to form a leadframe. In some cases, the flat sheet of metal can be plated with one or more plating metals. The leadframe and the terminal row 310 can be pressed or bent into the shape of the terminal row 310. The leadframe including the terminal row 310 can then be placed into a mold, and a plastic material can be injected into the mold to form the wafer mold insert 330 around the terminal row 310. The terminal row 310 can then be sheared or cut away from the leadframe, and the individual terminal conductors of the terminal row 310 can then be further bent or otherwise formed to the shape as illustrated.

The wafer mold insert 330 of the wafer assembly 300 maintains the separation between and supports the terminal conductors in the terminal row 310. The wafer mold insert 330 also includes structural features for positioning and securing the wafer assembly 300 within the housing 100 of the connector 10. More particularly, the wafer mold insert 330 includes interlock flanges 332 and 333 (see FIG. 3C) at opposite sides of the wafer mold insert 330. The interlock flanges 332 and 333 are formed to be rectangular cuboids in shape in the example shown and include chamfered corners or edges, although the size and shape of the interlock flanges 332 and 333 can vary among the embodiments. The interlock flanges 332 and 333 are sized to fit and slide within the wafer datum channels 131 and 134 of the housing 100, respectively, with a minimal clearance between them, when the connector 10 is assembled.

The interlock flanges 332 and 333 are also designed to mechanically interface with the latch fingers 152 and 156, respectively, and lock into position within the housing 100. As noted above, the latch fingers 152 and 156 can bend to some extent upon the application of forces against them. The latch fingers 152 and 156 are also elastic and will return to the position shown in FIGS. 1A and 1B when such forces are withdrawn. During assembly of the connector 10, the wafer assembly 300 is positioned so that the interlock flanges 332 and 333 are aligned with the wafer datum channels 131 and 134 of the housing 100. The wafer assembly 300 can then be inserted into the internal region 102 of the housing 100 in the direction “D” shown in FIG. 1D, and the interlock flanges 332 and 333 can slide within the wafer datum channels 131 and 134 of the housing 100. As the interlock flanges 332 and 333 slide within the wafer datum channels 131 and 134, the interlock flanges 332 and 333 will interfere with the tips or ends of the latch fingers 152 and 156, pushing the latch fingers 152 and 156 out within the openings 142 and 146. When the interlock flanges 332 and 333 are pushed past the tips or ends of the latch fingers 152 and 156, the latch fingers 152 and 156 can snap back and behind the interlock flanges 332 and 333 of the wafer mold insert 330 of the wafer assembly 300, securing the wafer assembly 300 in place within the housing 100.

The wafer mold inserts 430 and 430A of the wafer assembly 400 can be formed from plastic, such as LCP, PE, PTFE, fluoropolymer, or other plastic or insulating material(s) and is molded around the terminal conductors in the terminal row 410. For example, a leadframe including the terminal row 410 can be formed (e.g., stamped, sheared, or otherwise formed) from a flat sheet of metal to form a leadframe. In some cases, the flat sheet of metal can be plated with one or more plating metals. The leadframe and the terminal row 410 can be pressed or bent into the shape of the terminal row 410. The leadframe including the terminal row 410 can then be placed into a mold, and a plastic material can be injected into the mold to form the wafer mold inserts 430 and 430A around the terminal row 410. The terminal row 410 can then be sheared or cut away from the leadframe, and the individual terminal conductors of the terminal row 410 can then be further bent or otherwise formed to the shape as illustrated.

The wafer mold inserts 430 and 430A of the wafer assembly 400 maintain the separation between and supports the terminal conductors in the terminal row 410. The wafer mold inserts 430 and 430A also includes structural features for positioning and securing the wafer assembly 400 within the housing 100 of the connector 10. More particularly, the wafer mold insert 430 includes interlock flanges 432 and 433 (see FIG. 3B) at opposite sides of the wafer mold insert 430. The interlock flanges 432 and 433 are formed to be rectangular cuboids in shape in the example shown and include chamfered corners or edges, although the size and shape of the interlock flanges 432 and 433 can vary among the embodiments. The interlock flanges 432 and 433 are sized to fit and slide within the wafer datum channels 132 and 135 of the housing 100, respectively, with a minimal clearance between them, when the connector 10 is assembled.

The interlock flanges 432 and 433 are also designed to mechanically interface with the latch fingers 150 and 154, respectively, and lock into position within the housing 100. As noted above, the latch fingers 150 and 154 can bend to some extent upon the application of forces against them. The latch fingers 150 and 154 are also elastic and will return to the position shown in FIGS. 1A and 1B when such forces are withdrawn. During assembly of the connector 10, the wafer assembly 400 is positioned so that the interlock flanges 432 and 433 are aligned with the wafer datum channels 132 and 135 of the housing 100. The wafer assembly 400 can then be inserted into the internal region 102 of the housing 100 in the direction “D” shown in FIG. 1D, and the interlock flanges 432 and 433 can slide within the wafer datum channels 132 and 135 of the housing 100. As the interlock flanges 432 and 433 slide within the wafer datum channels 132 and 135, the interlock flanges 432 and 433 will interfere with the tips or ends of the latch fingers 150 and 154, pushing the latch fingers 150 and 154 out within the openings 140 and 144. When the interlock flanges 432 and 433 are pushed past the tips or ends of the latch fingers 150 and 154, the latch fingers 150 and 154 can snap back and behind the interlock flanges 432 and 433 of the wafer mold insert 430 of the wafer assembly 400, securing the wafer assembly 400 in place within the housing 100.

Additionally, the wafer mold insert 430A includes guide flanges 432A and 433A (see FIG. 3C) at opposite ends of the wafer mold insert 430A. The guide flanges 432A and 433A are formed to be rectangular cuboids in shape in the example shown and include chamfered corners or edges, although the size and shape of the guide flanges 432A and 433A can vary among the embodiments. The guide flanges 432A and 433A are sized to fit and slide within the wafer datum channels 130 and 133 of the housing 100, respectively, with a minimal clearance between them, when the connector 10 is assembled. During assembly of the connector 10, the wafer assembly 400 is positioned so that the guide flanges 432A and 433A are aligned with the wafer datum channels 130 and 133 of the housing 100. The wafer assembly 400 is inserted into the internal region 102 of the housing 100 in the direction “D” shown in FIG. 1D, and the guide flanges 432A and 433A can slide within the wafer datum channels 130 and 133 of the housing 100. In some cases, the wafer assembly 400 can be united or joined with (e.g., assembled with) the wafer assembly 500, and the wafer assemblies 400 and 500 can be inserted into the housing 100 together. However, in other embodiments, the wafer assemblies 400 and 500 can be separately inserted into the internal region 102 of the housing 100

The wafer mold insert 430 also includes positioning sockets. Particularly, the wafer mold insert 430 includes positioning sockets 442 and 443 formed, respectively, in the top surfaces of the interlock flanges 432 and 433, as shown in FIG. 3B. The positioning sockets 442 and 443 are formed as recessed sockets within the interlock flanges 432 and 433. Positioning posts of the wafer assembly 500 can be positioned to extend within the positioning sockets 442 and 443, as described in further detail below.

The wafer mold inserts 530 and 530A of the wafer assembly 500 can be formed from plastic, such as LCP, PE, PTFE, fluoropolymer, or other plastic or insulating material(s) and is molded around the terminal conductors in the terminal row 510. For example, a leadframe including the terminal row 510 can be formed (e.g., stamped, sheared, or otherwise formed) from a flat sheet of metal to form a leadframe. In some cases, the flat sheet of metal can be plated with one or more plating metals. The leadframe and the terminal row 510 can be pressed or bent into the shape of the terminal row 510. The leadframe including the terminal row 510 can then be placed into a mold, and a plastic material can be injected into the mold to form the wafer mold inserts 530 and 530A around the terminal row 510. The terminal row 510 can then be sheared or cut away from the leadframe, and the individual terminal conductors of the terminal row 510 can then be further bent or otherwise formed to the shape as illustrated.

The wafer mold inserts 530 and 530A of the wafer assembly 500 maintain the separation between and supports the terminal conductors in the terminal row 510. The wafer mold inserts 530 and 530A also includes structural features for positioning and securing the wafer assembly 500 within the housing 100 of the connector 10. More particularly, the wafer mold insert 530 includes guide flanges 532 and 533 (see FIG. 3A) at opposite sides of the wafer mold insert 530. The guide flanges 532 and 533 are sized to fit and slide within wafer datum channels of the housing 100 with a minimal clearance between them when the connector 10 is assembled.

Additionally, the wafer mold insert 530A includes guide flanges 532A and 533A (see FIG. 3A) at opposite ends of the wafer mold insert 530A. The guide flanges 532A and 533A are formed to be rectangular cuboids in shape in the example shown and include chamfered corners or edges, although the size and shape of the guide flanges 532A and 533A can vary among the embodiments. The guide flanges 532A and 533A are sized to fit and slide within the wafer datum channels 130 and 133 of the housing 100, respectively, with a minimal clearance between them, when the connector 10 is assembled. During assembly of the connector 10, the wafer assembly 500 is positioned so that the guide flanges 532A and 533A are aligned with the wafer datum channels 130 and 133 of the housing 100. The wafer assembly 500 is inserted into the internal region 102 of the housing 100 in the direction “D” shown in FIG. 1D, and the guide flanges 532A and 533A can slide within the wafer datum channels 130 and 133 of the housing 100.

The wafer mold insert 530 also includes positioning posts. Particularly, the wafer mold insert 530 includes positioning posts 542 and 543 that extend down from along the bottom edges of the guide flanges 532 and 533, as shown in FIG. 4A. The positioning posts 542 and 543 of the wafer assembly 500 can be positioned to extend within the positioning sockets 442 and 443 of the wafer assembly 400. That is, the wafer assembly 500 can be positioned over the wafer assembly 400, and the positioning posts 542 and 543 can be inserted into the positioning sockets 442 and 443 of the wafer assembly 400. The positioning posts 542 and 543 and the positioning sockets 442 and 443 provide a mechanism to align the wafer assemblies 400 and 500 together. The wafer assemblies 400 and 500 can then be inserted, together, into the internal region 102 of the housing 100 as described herein.

The wafer mold insert 530 also includes an interlock nose 539 for positioning the wafer assembly 500 within the housing 100 of the connector 10. The interlock nose 539 is positioned at a relative center of the wafer assembly 500 and is formed as an elongated nose. The interlock nose 539 fits and extends into a corresponding positioning aperture 138 (see FIG. 1A) within the housing 100 when the connector 10 is assembled. That is, the interlock nose 539 fits within and occupies the positioning aperture 137 with a minimal clearance between the outer surfaces of the interlock nose 539 and the inner surfaces of the positioning aperture 137 when the connector 10 is assembled.

Turning to other aspects of the embodiments, FIG. 4A illustrates a partly exploded view of the wafer assembly 200 of the connector 10 shown in FIG. 1A. The wafer assembly 200 includes flexible shields 250 and 260 and rigid shields 270 and 280. The flexible shields 250 and 260 and rigid shields 270 and 280 form a ground path assembly for the wafer assembly 200. The ground path assembly is also electrically coupled with and includes the ground conductors in the terminal row 210, including the ground conductors 211, 214, and others. The rigid shields 270 and 280 of the wafer assembly 200 can be formed (e.g., stamped, sheared, or otherwise formed) from a flat sheet of metal and plated in some cases. The flat sheet of metal from which the rigid shields 270 and 280 are formed can be relatively thicker than that used to form the flexible shields 250 and 260, as described in further detail below. The rigid shields 270 and 280 are designed to be secured with the wafer assembly 200 and provide strength, support, and additional rigidity for the wafer assembly 200 and the connector 10.

The rigid shield 270 includes a first segment 270A, a second segment 270B, and a third segment 270C in the example shown in FIG. 4A, with bends between the segments 270A-270C. The segments 270A-270C extend in different directions and at angles with respect to each other. The rigid shield 270 is generally formed to follow the bends in the terminal row 210 of conductors. The rigid shield 270 also includes contact surface regions 271, shield extension regions 272, and staking apertures 273. Similar to the rigid shield 270, the rigid shield 280 includes multiple segments with bends between the segments. The rigid shield 280 also includes contact surface regions 281, shield extension regions 282, and staking apertures 283.

The rigid shields 270 and 280 are formed separately from the terminal row 210 and the wafer mold insert 230. As shown in FIG. 4A, the wafer mold insert 230 includes staking posts, such as the staking posts 236 and 237, among others. When the wafer mold insert 230 is first molded around the terminal row 210, the staking posts 236 and 237 can be cylindrical as shown in FIG. 4A. To assemble the wafer assembly 200, the rigid shields 270 and 280 are arranged with the wafer mold insert 230 such that the staking posts 236 and 237 extend through the staking apertures 273 and 283 of the rigid shields 270 and 280. A heat staking process is then performed to heat the staking posts 236 and 237 above the melt temperature of the material from which the wafer mold insert 230 is formed, and the ends of the staking posts 236 and 237 are pressed and formed into caps, with part of the caps pressing against the back surfaces of the rigid shields 270 and 280. This process secures the rigid shield 270 and 280 with the wafer mold insert 230.

The contact surface regions 271 of the rigid shield 270 contact surfaces of the ground conductors in the terminal row 210 when the wafer assembly 200 is assembled. For example, the contact surface regions 271 of the rigid shield 270 contact lengths of the ground conductors in the first group 210A of terminal conductors in terminal row 210, including the ground conductors 211 and 214, among others. The shield extension regions 272 are mechanically and electrically separated with a clearance from and do not contact the signal conductors in the first group 210A of terminal conductors. For example, the rigid shield 270 does not contact the signal conductors 212 and 213 or any of the other signal conductors in the terminal row 210.

The contact surface regions 281 of the rigid shield 280 also contact surfaces of the ground conductors in the terminal row 210 when the wafer assembly 200 is assembled. For example, the contact surface regions 281 of the rigid shield 280 contact lengths of the ground conductors in the second group 210B of terminal conductors in terminal row 210. The shield extension regions 282 are separated from and do not contact the signal conductors in the second group 210B of terminal conductors.

In some cases, the contact surface regions 271 of the rigid shield 270 and the contact surface regions 281 of the rigid shield 280 can be electrically coupled or terminated to upper surface regions of the ground conductors in the terminal row 210 by welding (e.g., laser, spot, etc.), soldering, conductive adhesives, or other means. The electrical contact and termination by welding, soldering, adhesives, or other means can be established along lengths of the contact surface regions 271 and 281 and the ground conductors in the terminal row 210, for example, or at certain spots or areas along the contact surface regions 271 and 281 and the ground conductors in the terminal row 210.

The flexible shields 250 and 260 of the wafer assembly 200 can be formed (e.g., stamped, sheared, or otherwise formed) from a flat sheet of metal and plated in some cases. The flat sheet of metal from which the flexible shields 250 and 260 are formed can be relatively thinner than that used to form the rigid shields 270 and 280 in some cases. The flexible shields 250 and 260 are designed to be relatively more compliant than the rigid shields 270 and 280, so that the lead contacts of the terminal row 210 can bend and spring to some extent as a PCB-style interface of a connector is inserted into the front port opening 12 of the connector 10 and between the terminal rows 210 and 510.

The flexible shield 250 includes contact surface regions 251 and shield extension regions 252. Similar to the flexible shield 250, the flexible shield 260 includes contact surface regions 261 and shield extension regions 262. The contact surface regions 251 of the flexible shield 250 contact lower surfaces of the ground conductors in the terminal row 210 when the wafer assembly 200 is assembled. For example, the contact surface regions 251 of the flexible shield 250 contact lengths of the ground conductors in the first group 210A of terminal conductors in terminal row 210, including the ground conductors 211 and 214, among others. The shield extension regions 252 are mechanically and electrically separated with a clearance from and do not contact the signal conductors in the first group 210A of terminal conductors. The contact surface regions 261 of the flexible shield 260 also contact lower surfaces of the ground conductors in the terminal row 210 when the wafer assembly 200 is assembled. For example, the contact surface regions 261 of the flexible shield 260 contact lengths of the ground conductors in the second group 210B of terminal conductors in terminal row 210. The shield extension regions 262 are mechanically and electrically separated with a clearance from and do not contact the signal conductors in the second group 210B of terminal conductors.

In some cases, the contact surface regions 251 of the flexible shield 250 and the contact surface regions 261 of the flexible shield 260 can be electrically coupled or terminated to lower surface regions of the ground conductors in the terminal row 210 by welding (e.g., laser, spot, etc.), soldering, conductive adhesives, or other means. The electrical contact and termination by welding, soldering, adhesives, or other means can be established along lengths of the contact surface regions 251 and 261 and ground conductors in the terminal row 210, for example, or at certain spots or areas along the contact surface regions 251 and 261 and the ground conductors in the terminal row 210.

The flexible shields 250 and 260 and rigid shields 270 and 280 form a ground path assembly for the wafer assembly 200. The flexible shields 250 and 260 and rigid shields 270 and 280 provide a grounding structure to mitigate crosstalk, electromagnetic interference, and other unwanted effects for the wafer assembly 200 and also among the wafer assemblies 200, 300, 400, and 500 within the connector 10. The grounding structure also helps to control the impedances of the signal conductors in the terminal row 210, which act as transmission lines for data communications. The grounding structure provided by the flexible shields 250 and 260 and rigid shields 270 and 280 facilitates higher data rate applications for the connector 10, such as data rates at 56 gigabytes/second (Gb/s), 112 Gb/s, 224 Gb/s, and faster.

FIG. 4B illustrates a partly exploded view of the wafer assembly 300 of the connector 10 shown in FIG. 1A. The wafer assembly 300 includes flexible shields 350 and 360 and rigid shields 370 and 380. The flexible shields 350 and 360 and rigid shields 370 and 380 form a ground path assembly for the wafer assembly 300. The ground path assembly is also electrically coupled with and includes the ground conductors in the terminal row 310, including the ground conductors 311, 314, and others. The rigid shields 370 and 380 of the wafer assembly 300 can be formed (e.g., stamped, sheared, or otherwise formed) from a flat sheet of metal and plated in some cases. The flat sheet of metal from which the rigid shields 370 and 380 are formed can be relatively thicker than that used to form the flexible shields 350 and 360, as described in further detail below. The rigid shields 370 and 380 are designed to be secured with the wafer assembly 300 and provide strength, support, and additional rigidity for the wafer assembly 300 and the connector 10.

The rigid shield 370 includes a first segment 370A and a second segment 370B in the example shown in FIG. 4B, with bends between the segments 370A and 370B. The segments 370A and 370B extend in different directions and at angles with respect to each other. The rigid shield 370 is generally formed to follow the bends in the terminal row 310 of conductors. The rigid shield 370 also includes contact surface regions 371, shield extension regions 372, and staking apertures 373. Similar to the rigid shield 370, the rigid shield 380 includes multiple segments with bends between the segments. The rigid shield 380 also includes contact surface regions 381, shield extension regions 382, and staking apertures 383.

The rigid shields 370 and 380 are formed separately from the terminal row 310 and the wafer mold insert 330. As shown in FIG. 4B, the wafer mold insert 330 includes staking posts, such as the staking posts 336 and 337, among others. When the wafer mold insert 330 is first molded around the terminal row 310, the staking posts 336 and 337 can be cylindrical as shown in FIG. 4B. To assemble the wafer assembly 300, the rigid shields 370 and 380 are arranged with the wafer mold insert 330 such that the staking posts 336 and 337 extend through the staking apertures 373 and 383 of the rigid shields 370 and 380. A heat staking process is then performed to heat the staking posts 336 and 337 above the melt temperature of the material from which the wafer mold insert 330 is formed, and the ends of the staking posts 336 and 337 are pressed and formed into caps, with part of the caps pressing against the back surfaces of the rigid shields 370 and 380. This process secures the rigid shield 370 and 380 with the wafer mold insert 330.

The contact surface regions 371 of the rigid shield 370 contact surfaces of the ground conductors in the terminal row 310 when the wafer assembly 300 is assembled. For example, the contact surface regions 371 of the rigid shield 370 contact lengths of the ground conductors in the terminal row 310, including the ground conductors 311 and 314, among others. The shield extension regions 372 are mechanically and electrically separated with a clearance from and do not contact the signal conductors in the terminal row 310. The contact surface regions 381 of the rigid shield 380 also contact surfaces of the ground conductors in the terminal row 310 when the wafer assembly 300 is assembled. The shield extension regions 382 are separated from and do not contact the signal conductors in the terminal row 310.

In some cases, the contact surface regions 371 of the rigid shield 370 and the contact surface regions 381 of the rigid shield 380 can be electrically coupled or terminated to lower surface regions of the ground conductors in the terminal row 310 by welding (e.g., laser, spot, etc.), soldering, conductive adhesives, or other means. The electrical contact and termination by welding, soldering, adhesives, or other means can be established along lengths of the contact surface regions 371 and 381 and the ground conductors in the terminal row 310, for example, or at certain spots or areas along the contact surface regions 371 and 381.

The flexible shields 350 and 360 of the wafer assembly 300 can be formed (e.g., stamped, sheared, or otherwise formed) from a flat sheet of metal and plated in some cases. The flat sheet of metal from which the flexible shields 350 and 360 are formed can be relatively thinner than that used to form the rigid shields 370 and 380 in some cases. The flexible shields 350 and 360 are designed to be relatively more compliant than the rigid shields 370 and 380, so that the lead contacts of the terminal row 310 can bend and spring to some extent as a PCB-style interface of a connector is inserted into the front port opening 12 of the connector 10 and between the terminal rows 310 and 410.

The flexible shield 350 includes contact surface regions 351 and shield extension regions 352. Similar to the flexible shield 350, the flexible shield 360 includes contact surface regions 361 and shield extension regions 362. The contact surface regions 351 of the flexible shield 350 contact lower surfaces of the ground conductors in the terminal row 310 when the wafer assembly 300 is assembled. For example, the contact surface regions 351 of the flexible shield 350 contact lengths of the ground conductors in terminal row 310, including the ground conductors 311 and 314, among others. The shield extension regions 352 are mechanically and electrically separated with a clearance from and do not contact the signal conductors in the terminal row 310. The contact surface regions 361 of the flexible shield 360 also contact lower surfaces of the ground conductors in the terminal row 310 when the wafer assembly 300 is assembled. The shield extension regions 362 are mechanically and electrically separated from and do not contact the signal conductors in the terminal row 310.

In some cases, the contact surface regions 351 of the flexible shield 350 and the contact surface regions 361 of the flexible shield 360 can be electrically coupled or terminated to lower surface regions of the ground conductors in the terminal row 310 by welding (e.g., laser, spot, etc.), soldering, conductive adhesives, or other means. The electrical contact or termination by welding, soldering, adhesives, or other means can be established along the lengths of the contact surface regions 351 and 361, for example, or at certain spots or areas along the contact surface regions 351 and 361.

The flexible shields 350 and 360 and rigid shields 370 and 380 form a ground path assembly for the wafer assembly 300. The flexible shields 350 and 360 and rigid shields 370 and 380 provide a grounding structure to mitigate crosstalk, electromagnetic interference, and other unwanted effects for the wafer assembly 300 and also among the wafer assemblies 200, 300, 400, and 500 within the connector 10. The grounding structure also helps to control the impedances of the signal conductors in the terminal row 310, which act as transmission lines for data communications. The grounding structure provided by the flexible shields 350 and 360 and rigid shields 370 and 380 facilitates higher data rate applications for the connector 10.

FIG. 4C illustrates a partly exploded view of the wafer assembly 400 of the connector 10 shown in FIG. 1A. The wafer assembly 400 includes flexible shields 450 and 460 and rigid shields 470 and 480. The flexible shields 450 and 460 and rigid shields 470 and 480 form a ground path assembly for the wafer assembly 400. The ground path assembly is also electrically coupled with and includes the ground conductors in the terminal row 410, including the ground conductors 411, 414, and others. The rigid shields 470 and 480 of the wafer assembly 400 can be formed (e.g., stamped, sheared, or otherwise formed) from a flat sheet of metal and plated in some cases. The flat sheet of metal from which the rigid shields 470 and 480 are formed can be relatively thicker than that used to form the flexible shields 450 and 460, as described in further detail below. The rigid shields 470 and 480 are designed to be secured with the wafer assembly 400 and provide strength, support, and additional rigidity for the wafer assembly 400 and the connector 10.

The rigid shield 470 includes a first segment 470A and a second segment 470B in the example shown in FIG. 4C, with bends between the segments 470A and 470B. The segments 470A and 470B extend in different directions and at angles with respect to each other. The rigid shield 470 is generally formed to follow the bends in the terminal row 410 of conductors. The rigid shield 470 also includes contact surface regions 471, shield extension regions 472, and staking apertures 473. Similar to the rigid shield 470, the rigid shield 480 includes multiple segments with bends between the segments. The rigid shield 480 also includes contact surface regions 481, shield extension regions 482, and staking apertures 483.

The rigid shields 470 and 480 are formed separately from the terminal row 410 and the wafer mold insert 430. As shown in FIG. 4C, the wafer mold insert 430 includes staking posts, such as the staking posts 436 and 437, among others. When the wafer mold insert 430 is first molded around the terminal row 410, the staking posts 436 and 437 can be cylindrical as shown in FIG. 4C. To assemble the wafer assembly 400, the rigid shields 470 and 480 are arranged with the wafer mold insert 430 such that the staking posts 436 and 437 extend through the staking apertures 473 and 483 of the rigid shields 470 and 480. A heat staking process is then performed to heat the staking posts 436 and 437 above the melt temperature of the material from which the wafer mold insert 430 is formed, and the ends of the staking posts 436 and 437 are pressed and formed into caps, with part of the caps pressing against the back surfaces of the rigid shields 470 and 480. This process secures the rigid shield 470 and 480 with the wafer mold insert 440.

The contact surface regions 471 of the rigid shield 470 contact surfaces of the ground conductors in the terminal row 410 when the wafer assembly 400 is assembled. For example, the contact surface regions 471 of the rigid shield 470 contact lengths of the ground conductors in the terminal row 410, including the ground conductors 411 and 414, among others. The shield extension regions 472 are mechanically and electrically separated with a clearance from and do not contact the signal conductors in the terminal row 410. The contact surface regions 481 of the rigid shield 480 also contact surfaces of the ground conductors in the terminal row 410 when the wafer assembly 400 is assembled. The shield extension regions 482 are separated from and do not contact the signal conductors in the terminal row 410.

In some cases, the contact surface regions 471 of the rigid shield 470 and the contact surface regions 481 of the rigid shield 480 can be electrically coupled or terminated to upper surface regions of the ground conductors in the terminal row 410 by welding (e.g., laser, spot, etc.), soldering, conductive adhesives, or other means. The electrical contact and termination by welding, soldering, adhesives, or other means can be established along the lengths of the contact surface regions 471 and 481 and the ground conductors in the terminal row 410, for example, or at certain spots or areas along the contact surface regions 471 and 481.

The flexible shields 450 and 460 of the wafer assembly 400 can be formed (e.g., stamped, sheared, or otherwise formed) from a flat sheet of metal and plated in some cases. The flat sheet of metal from which the flexible shields 450 and 460 are formed can be relatively thinner than that used to form the rigid shields 470 and 480 in some cases. The flexible shields 450 and 460 are designed to be relatively more compliant than the rigid shields 470 and 480, so that the lead contacts of the terminal row 410 can bend and spring to some extent as a PCB-style interface of a connector is inserted into the front port opening 12 of the connector 10 and between the terminal rows 410 and 410.

The flexible shield 450 includes contact surface regions and shield extension regions, and the flexible shield 460 also includes contact surface regions and shield extension regions. The contact surface regions of the flexible shield 450 contact upper surfaces of the ground conductors in the terminal row 410 when the wafer assembly 400 is assembled. The shield extension regions of the flexible shield 450 are mechanically and electrically separated with a clearance from and do not contact the signal conductors in the terminal row 410. The contact surface regions of the flexible shield 460 also contact upper surfaces of the ground conductors in the terminal row 410 when the wafer assembly 400 is assembled. The shield extension regions of the flexible shield 460 are mechanically and electrically separated with a clearance from and do not contact the signal conductors in the terminal row 410. In some cases, the contact surface regions of the flexible shield 450 and the contact surface regions of the flexible shield 460 can be electrically coupled or terminated to the upper surface regions of the ground conductors in the terminal row 410 by welding (e.g., laser, spot, etc.), soldering, conductive adhesives, or other means. The electrical contact and termination by welding, soldering, adhesives, or other means can be established along the lengths of the contact surface regions, for example, or at certain spots or areas along the contact surface regions.

The flexible shields 450 and 460 and rigid shields 470 and 480 form a ground path assembly for the wafer assembly 400. The flexible shields 450 and 460 and rigid shields 470 and 480 provide a grounding structure to mitigate crosstalk, electromagnetic interference, and other unwanted effects for the wafer assembly 400 and also among the wafer assemblies 200, 300, 400, and 500 within the connector 10. The grounding structure also helps to control the impedances of the signal conductors in the terminal row 410, which act as transmission lines for data communications. The grounding structure provided by the flexible shields 450 and 460 and rigid shields 470 and 480 facilitates higher data rate applications for the connector 10.

FIG. 4D illustrates a partly exploded view of the wafer assembly 500 of the connector 10 shown in FIG. 1A. The wafer assembly 500 includes flexible shields 550 and 560 and rigid shields 570 and 580. The flexible shields 550 and 560 and rigid shields 570 and 580 form a ground path assembly for the wafer assembly 500. The ground path assembly is also electrically coupled with and includes the ground conductors in the terminal row 510, including the ground conductors 511, 514, and others. The rigid shields 570 and 580 of the wafer assembly 500 can be formed (e.g., stamped, sheared, or otherwise formed) from a flat sheet of metal and plated in some cases. The flat sheet of metal from which the rigid shields 570 and 580 are formed can be relatively thicker than that used to form the flexible shields 550 and 560, as described in further detail below. The rigid shields 570 and 580 are designed to be secured with the wafer assembly 500 and provide strength, support, and additional rigidity for the wafer assembly 500 and the connector 10.

The rigid shield 570 includes a first segment 570A, a second segment 570B, and a third segment 570C in the example shown in FIG. 4D, with bends between the segments 570A-570C. The segments 570A-570C extend in different directions and at angles with respect to each other. The rigid shield 570 is generally formed to follow the bends in the terminal row 510 of conductors. The rigid shield 570 also includes contact surface regions 571, shield extension regions 572, and staking apertures 573. Similar to the rigid shield 570, the rigid shield 580 includes multiple segments with bends between the segments. The rigid shield 580 also includes contact surface regions 581, shield extension regions 582, and staking apertures 583.

The rigid shields 570 and 580 are formed separately from the terminal row 510 and the wafer mold insert 530. As shown in FIG. 4D, the wafer mold insert 530 includes staking posts, such as the staking posts 536 and 537, among others. When the wafer mold insert 530 is first molded around the terminal row 510, the staking posts 536 and 537 can be cylindrical as shown in FIG. 4D. To assemble the wafer assembly 500, the rigid shields 570 and 580 are arranged with the wafer mold insert 530 such that the staking posts 536 and 537 extend through the staking apertures 573 and 583 of the rigid shields 570 and 580. A heat staking process is then performed to heat the staking posts 536 and 537 above the melt temperature of the material from which the wafer mold insert 530 is formed, and the ends of the staking posts 536 and 537 are pressed and formed into caps, with part of the caps pressing against the back surfaces of the rigid shields 570 and 580. This process secures the rigid shield 570 and 580 with the wafer mold insert 530.

The contact surface regions 571 of the rigid shield 570 contact surfaces of the ground conductors in the terminal row 510 when the wafer assembly 500 is assembled. For example, the contact surface regions 571 of the rigid shield 570 contact lengths of the ground conductors in the terminal row 510, including the ground conductors 511 and 514, among others. The shield extension regions 572 are mechanically and electrically separated with a clearance from and do not contact the signal conductors in the terminal row 510. The contact surface regions 581 of the rigid shield 580 also contact surfaces of the ground conductors in the terminal row 510 when the wafer assembly 500 is assembled. The shield extension regions 582 are separated from and do not contact the signal conductors in the terminal row 510.

In some cases, the contact surface regions 571 of the rigid shield 570 and the contact surface regions 581 of the rigid shield 580 can be electrically coupled and terminated to lower surface regions of the ground conductors in the terminal row 510 by welding (e.g., laser, spot, etc.), soldering, conductive adhesives, or other means. The electrical contact and termination by welding, soldering, adhesives, or other means can be established along the lengths of the contact surface regions 571 and 581 and the ground conductors in the terminal row 510, for example, or at certain spots or areas along the contact surface regions 571 and 581.

The flexible shields 550 and 560 of the wafer assembly 500 can be formed (e.g., stamped, sheared, or otherwise formed) from a flat sheet of metal and plated in some cases. The flat sheet of metal from which the flexible shields 550 and 560 are formed can be relatively thinner than that used to form the rigid shields 570 and 580 in some cases. The flexible shields 550 and 560 are designed to be relatively more compliant than the rigid shields 570 and 580, so that the lead contacts of the terminal row 510 can bend and spring to some extent as a PCB-style interface of a connector is inserted into the front port opening 12 of the connector 10 and between the terminal rows 210 and 510.

The flexible shield 550 includes contact surface regions and shield extension regions, and the flexible shield 560 also includes contact surface regions and shield extension regions. The contact surface regions of the flexible shield 550 contact upper surfaces of the ground conductors in the terminal row 510 when the wafer assembly 500 is assembled. The shield extension regions of the flexible shield 550 are mechanically and electrically separated with a clearance from and do not contact the signal conductors in the terminal row 510. The contact surface regions of the flexible shield 560 also contact upper surfaces of the ground conductors in the terminal row 510 when the wafer assembly 500 is assembled. The shield extension regions of the flexible shield 560 are mechanically and electrically separated from and do not contact the signal conductors in the terminal row 510. In some cases, the contact surface regions of the flexible shield 550 and the contact surface regions of the flexible shield 560 can be electrically coupled and terminated to the upper surface regions of the ground conductors in the terminal row 510 by welding (e.g., laser, spot, etc.), soldering, conductive adhesives, or other means. The electrical contact and termination by welding, soldering, adhesives, or other means can be established along the lengths of the contact surface regions, for example, or at certain spots or areas along the contact surface regions.

The flexible shields 550 and 560 and rigid shields 570 and 580 form a ground path assembly for the wafer assembly 500. The flexible shields 550 and 560 and rigid shields 570 and 580 provide a grounding structure to mitigate crosstalk, electromagnetic interference, and other unwanted effects for the wafer assembly 500 and also among the wafer assemblies 200, 300, 400, and 500 within the connector 10. The grounding structure also helps to control the impedances of the signal conductors in the terminal row 510, which act as transmission lines for data communications. The grounding structure provided by the flexible shields 550 and 560 and rigid shields 570 and 580 facilitates higher data rate applications for the connector 10.

FIG. 5 illustrates the sectional view of the connector 10 designated B-B in FIG. 1D according to various embodiments of the present disclosure. As shown in FIG. 5, the housing 100 includes openings 147 and 148 that extend through the bottom of the housing 100. The openings 147 and 148 extend from outside the housing 100 to the internal region 102 (see also FIG. 1D) within the housing 100. A latch finger extends within each of the openings 147 and 148 in a cantilevered arrangement. Particularly, the leg latch fingers 157 and 158 extend in a cantilevered arrangement, respectively, around a periphery of the openings 147 and 148. Tapered edges of the leg latch fingers 157 and 158 also extend in part within the openings 147 and 148.

The wafer mold insert 230 of the wafer assembly 200 includes the interlock legs 234 and 235, as also shown in FIG. 2B, for positioning and securing the wafer assembly 200 within the housing 100. The interlock legs 234 and 235 are designed to mechanically interface with the leg latch fingers 157 and 158 of the housing 100, to maintain and secure the wafer assembly 200 in place. More particularly, during assembly of the connector 10, the wafer assembly 200 is positioned so that the guide flanges 232 and 233 (see FIG. 2B) are aligned with wafer datum channels of the housing 100. The wafer assembly 200 is then be inserted into the internal region 102 of the housing 100 in the direction “D” shown in FIG. 1D, and the guide flanges 232 and 233 slide within the wafer datum channels of the housing 100. At that time, the interlock legs 234 and 235 slide into the openings 148 and 147 of the housing 100 and push against the tapered edges of the leg latch fingers 157 and 158. The interlock legs 234 and 235 of the wafer assembly 200 push the leg latch fingers 157 and 158 away and towards the peripheral edges of the openings 148 and 147. When the interlock legs 234 and 235 are pushed past the tips or ends of the latch fingers 157 and 158, the leg latch fingers 157 and 158 can snap back and behind the interlock legs 234 and 235 of the wafer mold insert 230 of the wafer assembly 300, as shown in FIG. 5, securing the wafer assembly 200 in place within the housing 100.

FIG. 5 also illustrates how the contact surface regions of the rigid shields 270, 280, 370, 380, 470, 480, 570, and 580 contact ground conductors in the wafer assemblies 200, 300, 400, and 500 of the connector 10. The shield extension regions of the rigid shields 270, 280, 370, 380, 470, 480, 570, and 580 are mechanically and electrically separated from and do not contact signal conductors in the wafer assemblies 200, 300, 400, and 500 of the connector 10.

Next a connector 10 according to yet another embodiment of the present disclosure is described, where the part which is the same as that in various embodiments is still be designated with the same reference numeral, and in order to avoid redundancy, repeated description will be omitted with respect to the same part.

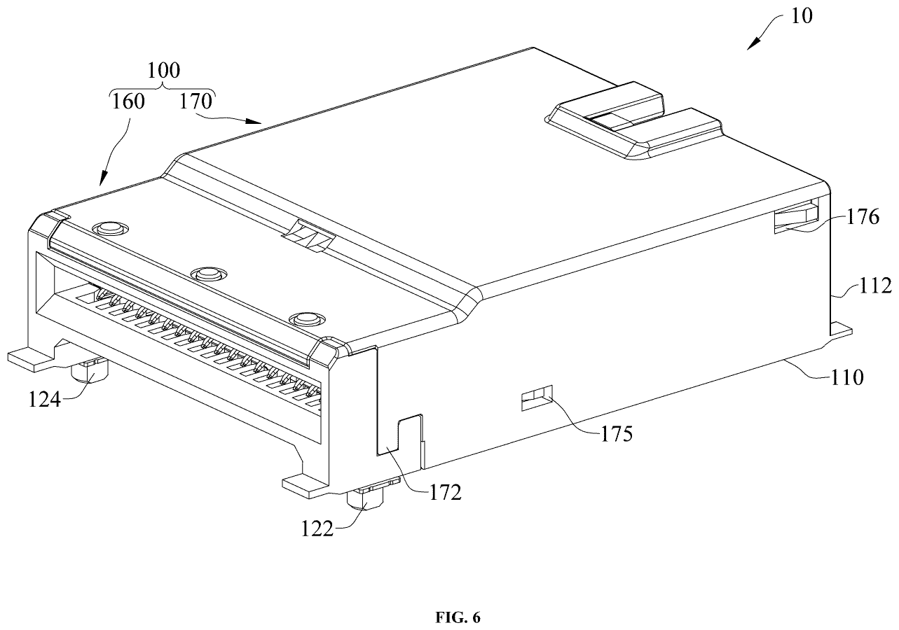

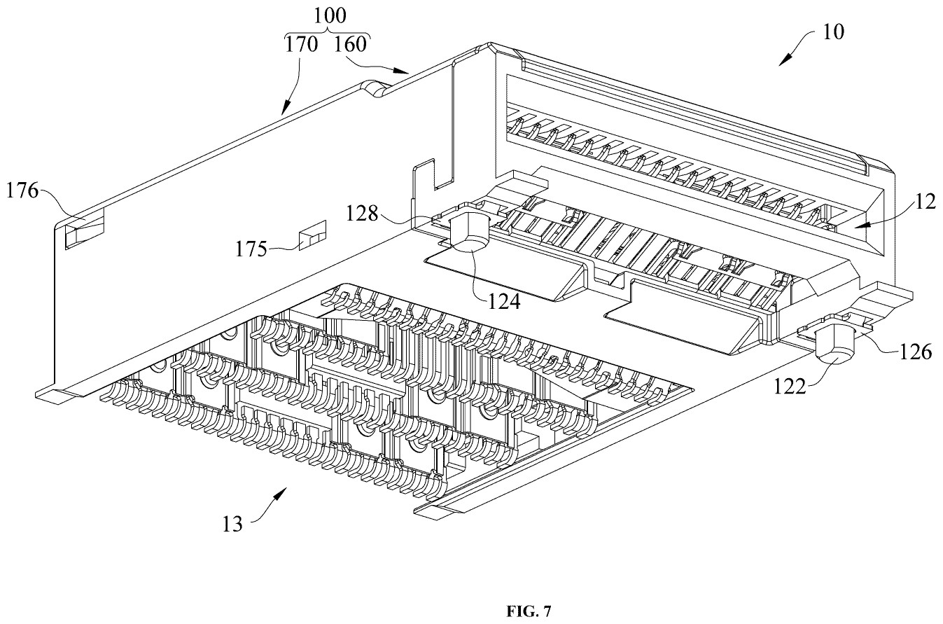

Referring to FIG. 6 and FIG. 7, FIG. 6 illustrates a top-down perspective view of an example connector according to yet another embodiment of the present disclosure, FIG. 7 illustrates a bottom-up perspective view of the connector shown in FIG. 6 according to the yet another embodiment of the present disclosure, the connector 10 of the yet another embodiment similarly includes a front port opening 12, a terminal foot 13 (shown in FIG. 7), and terminal rows of terminal conductors which extend from the terminal foot 13 to the front port opening 12 for the communication of data signals on the terminal conductors. The connector 10 similarly includes several structural features to maintain the alignment and position of the terminal conductors within the connector 10. The connector 10 is also designed to provide shielding and maintain the signal integrity of differential signals on the terminal conductors as the terminal conductors extend from the front port opening 12 to the terminal foot 13. The connector 10 similarly includes a housing 100, and the housing 100 includes a bottom mounting surface 110, a back surface 112, mounting posts 122 and 124, solder rings 126 and 128, and other features described below.

Difference from the previous various embodiments lies in that, the housing 100 of the yet another embodiment is consisted of a plastic portion 160 and a metal portion 170, the front port opening 12 is formed in the plastic portion 160, which on one hand may avoid a mating connector being possibly scratched when inserting via the front port opening 12, on the other hand also may avoid the mating connector occurring short-circuit with the housing during mating of the mating connector; the metal portion 170 may be formed for example by molding, injection molding, die cast, printing, and other techniques, to promote entire strength of the housing 100, when the wafer assemblies applies a force to the housing 100, the metal portion 170 also may promote capability of the housing 100 with resistance to deformation.

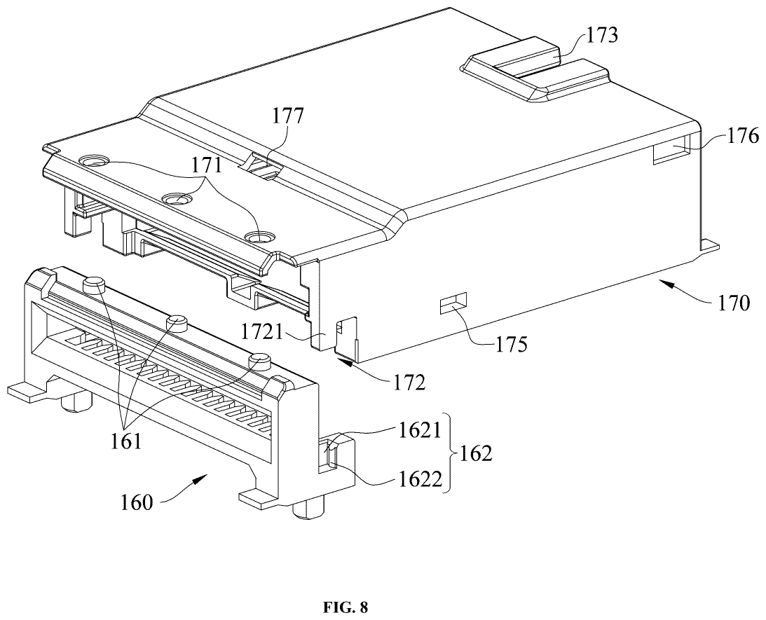

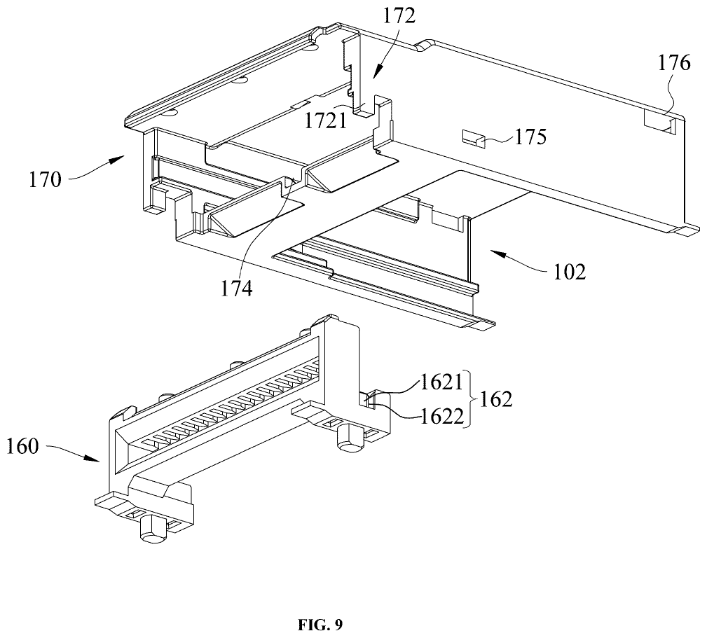

In combination with referring to FIG. 8 and FIG. 9, FIG. 8 illustrates a top-down exploded perspective view of the housing of the connector shown in FIG. 6 according to the yet another embodiment of the present disclosure, FIG. 9 illustrates a bottom-up exploded perspective view of the housing of the connector shown in FIG. 6 according to the yet another embodiment of the present disclosure, the plastic portion 160 of the housing 100 includes a first snapping portion 162, correspondingly, the metal portion 170 of the housing 100 includes a second snapping portion 172, in the example shown in FIG. 8 and FIG. 9, the first snapping portion 162 and the second snapping portion 172 are generally U-shaped, the first snapping portion 162 includes a snapping groove 1621 and a protruding rib 1622 positioned to one side or two sides of the snapping groove 1621 within the snapping groove 1621 (FIG. 8 and FIG. 9 only illustrate the protruding rib 1622 positioned to one side of the snapping groove 1621); the second snapping portion 172 includes a snapping arm 1721. But the present disclosure is not limited thereto, the first snapping portion 162 and the second snapping portion 172 also may have other forms, for example a form of a protrusion and a recess or a latching hole.

The plastic portion 160 of the housing 100 also includes a connection protruding portion 161, the connection protruding portion 161 shown in the figure is positioned on a top surface of the plastic portion 160, and is three protruding portions which each are a cylinder, but the present disclosure is not limited thereto, the connection protruding portion 161 also may be other shapes, for example a prism. Corresponding to the connection protruding portion 161, a top surface of the metal portion 170 is provided with three connection holes 171, a shape of the connection hole 171 may correspond to a shape of the connection protruding portion 161. The number of the connection protruding portion 161 and the number of the connection hole 171 may be appropriately provided according to practical needs.

When the plastic portion 160 and the metal portion 170 are assembled, the first snapping portion 162 and the second snapping portion 172 snap with each other, at the same time, the connection protruding portion 161 passes through the connection hole 171, and then for example an end portion of the connection protruding portion 161 is pressed by heat pressing to form a cap, so that the plastic portion 160 and the metal portion 170 are secured together. Certainly it also may be that, the connection protruding portion 161 and the connection hole 171 interference fit therebetween so that the plastic portion 160 and the metal portion 170 are secured with each other. Or it also may be that, the connection protruding portion 161 and the connection hole 171 interference fit with each other, then the end portion of the connection protruding portion 161 is pressed by heat pressing to form a cap which is secured to the connection hole 171. When the first snapping portion 162 and the second snapping portion 172 snap with each other, for example as shown in FIG. 8 and FIG. 9, the snapping arm 1721 of the second snapping portion 172 inserts into the snapping groove 1621 of the first snapping portion 162 and squeezes the protruding rib 1622 which is positioned to the one side or the two sides of the snapping groove 1621, so that tight fit/interference fit is formed between the first snapping portion 162 and the second snapping portion 172. By secure connection between the connection protruding portion 161 and the connection hole 171 and tight fit between the first snapping portion 162 and the second snapping portion 172, the plastic portion 160 and the metal portion 170 of the housing 100 are firmly assembled together.

As the same as the various embodiments, the housing 100 includes an internal space region 102, when the connector 10 is assembled, the wafer assemblies 200, 300, 400, and 500 are positioned and secured in the internal space region 102. In order to realize positioning and securing of the wafer assemblies 200, 300, 400, and 500 in the internal space region 102 of the housing 100, the metal portion 170 of the yet another embodiment also includes following features, that is, an end of the top surface of the metal portion 170 away from the plastic portion 160 is provided with a second positioning groove 173, an end of the top surface of the metal portion 170 close to the plastic portion 160 is provided with a snap groove 177, an end of a bottom surface of the metal portion 170 close to the plastic portion 160 is provided with a first positioning groove 174. The second positioning groove 173 for example may be in form of dovetail groove, the snap groove 177 for example may be in form of slot hole. Two side walls of the metal portion 170 each are provided with a first latching hole 175 and a second latching hole 176, FIG. 8 and FIG. 9 illustrate the first snapping holes 175 and the second snapping holes 176 respectively positioned on the two side walls. The cooperating relationship between the above features and the wafer assemblies 200, 300, 400, and 500 is described below.

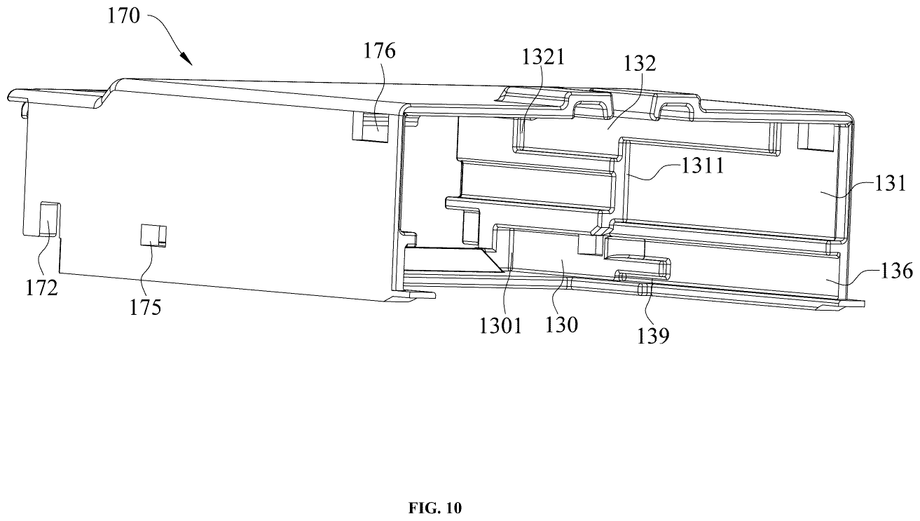

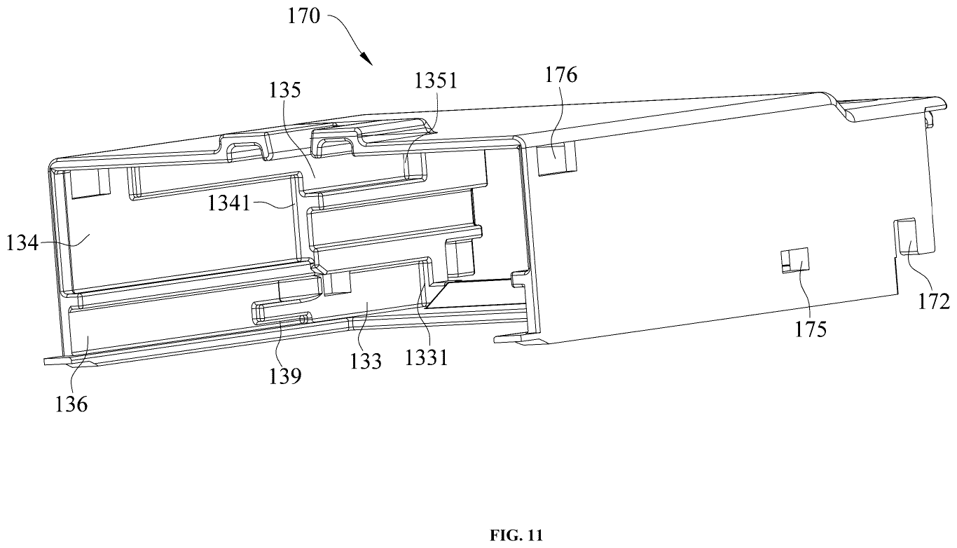

Referring to FIG. 10 and FIG. 11, FIG. 10 and FIG. 11 respectively illustrate a perspective views of an interior structure of the housing of the connector shown in FIG. 6 according to the yet another embodiment of the present disclosure from different angles, the housing 100 includes wafer datum channels 130, 131 and 132 (shown in FIG. 10) which are formed to one side wall inside the housing 100 and wafer datum channels 133, 134 and 135 (shown in FIG. 11) which are formed to the other facing side wall inside the housing 100. The wafer datum channels 130 and 133 are provided to face each other to form datum channels which allow the wafer assembly 200 (also referred to as the first wafer assembly 200 below) insert into, and end portions of the wafer datum channel 130 and 133 close to the front port opening 12 or the plastic portion 160 (shown in FIG. 6 and FIG. 7) are respectively formed with stopping edges 1301 and 1331 to limit a position that the first wafer assembly 200 inserts into the housing 100. Similarly, the wafer datum channels 131 and 134 are provided to face each other to form datum channels which allow the wafer assemblies 300 and 400 (also respectively referred to as a second wafer assembly 300 and a third wafer assembly 400 below) to insert into, end portions of the wafer datum channels 131 and 134 close to the front port opening 12 are respectively formed with stopping edges 1311 and 1341 to limit a position of the second wafer assembly 300 and a position of the third wafer assembly 400 that the second wafer assembly 300 and the third wafer assembly 400 insert into the housing 100. The wafer datum channels 132 and 135 are provided to face each other to form datum channels which allow the wafer assembly 500 (also referred to as a fourth wafer assembly 500 below) to insert into, end portions of the wafer datum channels 132 and 135 close to the front port opening 12 are respectively formed with stopping edges 1321 and 1351 to limit a position of the fourth wafer assembly 500 that the fourth wafer assembly 500 inserts into the housing 100.

In addition, as shown in FIG. 10 and FIG. 11, the two facing side walls inside the housing 100 are also respectively formed with two inserting grooves 139, two ends of a supporting plate 600 (will be described below) may respectively insert into the two inserting grooves 139.

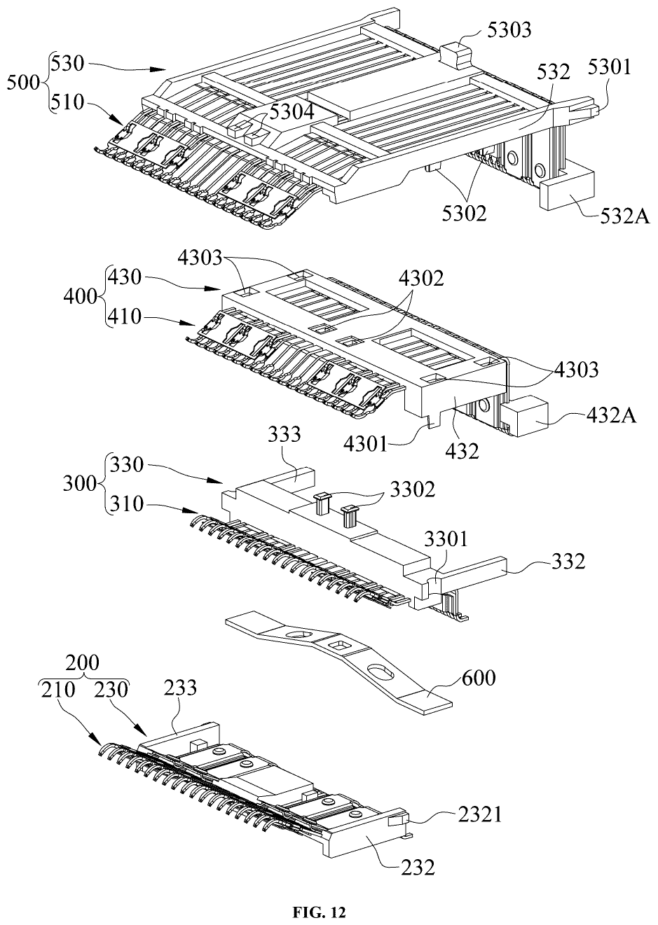

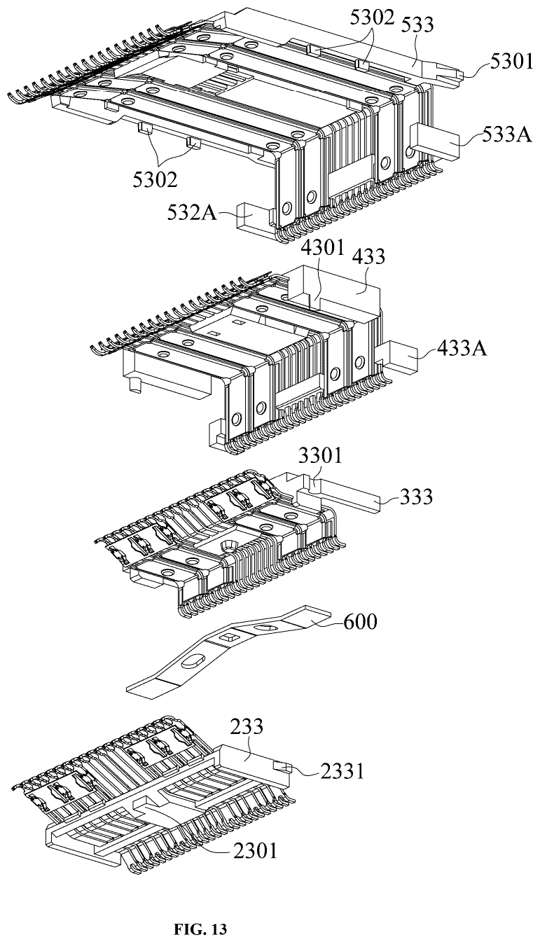

Next referring to FIG. 12 and FIG. 13, the first wafer assembly 200, the second wafer assembly 300, the third wafer assembly 400, and the fourth wafer assembly 500 according to the yet another embodiment of the present disclosure are described in detail, where, FIG. 12 illustrates a top-down exploded perspective view of the wafer assemblies of the connector according to the yet another embodiment of the present disclosure, FIG. 13 illustrates a bottom-up exploded perspective view of the wafer assemblies of the connector according to the yet another embodiment of the present disclosure.

The first wafer assembly 200 according to the yet another embodiment of the present disclosure similarly includes a terminal row 210 and a wafer mold insert 230, the wafer mold insert 230 maintains the separation between and supports the terminal conductors in the terminal row 210. The wafer mold insert 230 also includes structural features for positioning and securing the wafer assembly 200 within the housing 100 of the connector 10. More particularly, the wafer mold insert 230 includes guide flanges 232 and 233 positioned to two sides thereof for guiding the wafer assembly 200 within the housing 100 during assembly of the connector 10, the guide flanges 232 and 233 respectively engage with the wafer datum channels 130 and 133 (also, fit and slide within the wafer datum channels 130 and 133 with a minimal clearance), and an extreme position that the first wafer assembly 200 inserts into the housing 100 is limited by the stopping edges 1301 and 1331. The guide flanges 232 and 233 are respectively provided with first latching blocks 2321 (shown in FIG. 12) and 2331 (shown in FIG. 13), in combination with referring to FIG. 10 and FIG. 11, when the first wafer assembly 200 inserts into the housing 100 in place, the first latching blocks 2321 and 2331 respectively engage with the first latching holes 175 provided in the two side walls of the metal portion 170 of the housing 100, to realize positioning of the first wafer assembly 200 within the housing 100. Provided positions of the first latching blocks 2321 and 2331 and provided positions of the first latching holes 175 may be interchanged, also may employ other structural forms. According to the embodiment shown in FIG. 12 and FIG. 13, the first latching blocks 2321 and 2331 also may be provided with oblique surfaces respectively to perform guiding when the first latching blocks 2321 and 2331 engage into the first latching holes 175 respectively. In addition, as shown in FIG. 13, a bottom surface of the wafer mold insert 230 is provided with a first positioning block 2301, the first positioning block 2301 is provided close to the front port opening 12 or the plastic portion 160 relative to the first latching blocks 2321 and 2331. When the first wafer assembly 200 inserts into the housing 100 in place, the first positioning block 2301 engages with the first positioning groove 174 which is provided to the bottom surface of the metal portion 170 of the housing 100, in accordance with an embodiment, the first positioning block 2301 is a protruding block, the first positioning groove 174 is a recess, in combination with referring to FIG. 9 and FIG. 13, the first positioning block 2301 is biased and limited in the first positioning groove 174 by the supporting plate 600 (described below), so that positioning of the first positioning block 2301 along a left-right direction and an up-down direction may be realized, the first positioning block 2301 and the first positioning groove 174 may tight fit or loose fit therebetween. Certainly, a provided position of the first positioning block 2301 and a provided position of the first positioning groove 174 also may be interchanged, or employ other forms.

The second wafer assembly 300 according to the yet another embodiment of the present disclosure similarly includes a terminal row 310 and a wafer mold insert 330, the wafer mold insert 330 maintains the separation between and supports the terminal conductors in the terminal row 310. The wafer mold insert 330 also includes structural features for positioning and securing the wafer assembly 300 within the housing 100 of the connector 10. More particularly, the wafer mold insert 330 includes interlock flanges 332 (shown in FIG. 12) and 333 (shown in FIG. 13).

The third wafer assembly 400 according to the yet another embodiment of the present disclosure similarly also includes a terminal row 410 and a wafer mold insert 430, the wafer mold insert 430 maintains the separation between and supports the terminal conductors in the terminal row 410. The wafer mold insert 430 also includes structural features for positioning and securing the wafer assembly 400 within the housing 100 of the connector 10. More particularly, the wafer mold insert 430 includes interlock flanges 432 (shown in FIG. 12) and 433 (shown in FIG. 13).

In addition, as shown in FIG. 12 and FIG. 13, end surfaces of two sides of the wafer mold insert 330 of the second wafer assembly 300 each are provided with a first positioning hole 3301, end surfaces of two sides of the wafer mold insert 430 of the third wafer assembly 400 each are correspondingly provided with a first positioning post 4301, the first positioning post 4301 of the third wafer assembly 400 may insert into the first positioning hole 3301 of the second wafer assembly 300 to realize positioning between the second wafer assembly 300 and the third wafer assembly 400. A cross section of the first positioning hole 3301 shown in FIG. 12 and FIG. 13 is a semicircle, correspondingly, the first positioning post 4301 also is a cooperating semicylinder, but the present disclosure is not limited thereto, the first positioning post 4301 also may be a cylinder, a prism and the like, correspondingly, the cross section of the first positioning hole 3301 also may be a circle, a prism and the like. A provided position of the first positioning post 4301 and a provided position of the first positioning hole 3301 also may be interchanged. A top surface of the wafer mold insert 330 of the second wafer assembly 300 also is provided with a locking post 3302, correspondingly, a top surface of the wafer mold insert 430 of the third wafer assembly 400 is provided with a locking hole 4302, the locking post 3302 of the second wafer assembly 300 may pass through the locking hole 4302 of the third wafer assembly 400, then may be melted by heat pressing and the like to be secured to the locking hole 4302, also may use interference fit to secure the locking post 3302 to the locking hole 4302, or the locking post 3302 interference fits with the locking hole 4302 and then is melted by heat pressing to be secured to the locking hole 4302. The locking post 3302 shown in FIG. 12 and FIG. 13 is a quadrangular prism, correspondingly, a cross section of the locking hole 4302 also is a cooperating quadrilateral, but the present disclosure is not limited thereto, the locking post 3302 also may be a semicylinder, a cylinder, other prismatic shape and the like, correspondingly, the cross section of the locking hole 4302 also may be a semicircle, a circle, other prismatic shape and the like. A provided position of the locking post 3302 and a provided position of the locking hole 4302 also may be interchanged, the number of the locking post 3302 and the number of the locking hole 4302 also may be appropriately provided according to needs. Via cooperation between the first positioning posts 4301 and the first positioning holes 3301 and cooperation between the locking post 3302 and the locking hole 4302, the second wafer assembly 300 and the third wafer assembly 400 engage with each other as integral. After the connector 10 is mounted, the interlock flanges 332 and 432 which engage with each other and the interlock flanges 333 and 433 which engage with each other are respectively positioned within the datum channels 131 and 134 of the housing 100 with a minimal clearance, and may slide along the datum channels 131 and 134.

As shown in FIG. 12 and FIG. 13, besides the interlock flanges 432 and 433 of the wafer mold insert 430 of the third the wafer assembly 400, the wafer mold insert 430 of the third wafer assembly 400 also includes guide flanges 432A (shown in FIG. 12) and 433A (shown in FIG. 13). Two ends of the top surface of the wafer mold insert 430 of the third wafer assembly 400 each are provided with a second positioning hole 4303.

The fourth wafer assembly 500 according to the yet another embodiment of the present disclosure similarly also includes a terminal row 510 and a wafer mold insert 530, the wafer mold insert 530 maintains the separation between and supports the terminal conductors in the terminal row 510. The wafer mold insert 530 also includes structural features for positioning and securing the fourth wafer assembly 500 within the housing 100 of the connector 10. More particularly, the wafer mold insert 530 includes first guide flanges 532 (shown in FIG. 12) and 533 (shown in FIG. 13), and second guide flanges 532A (shown in FIG. 12) and 533A (shown in FIG. 13). Two sides of the wafer mold insert 530 of the fourth wafer assembly 500 each are provided with a second positioning post 5302, the second positioning posts 5302 may correspondingly insert into the second positioning holes 4303 of the third wafer assembly 400 to realize positioning and cooperating between the third wafer assembly 400 and the fourth wafer assembly 500. The second positioning post 5302 shown in FIG. 12 and FIG. 13 is a quadrangular prism, correspondingly, a cross section of the second positioning hole 4303 also is a cooperating quadrilateral, but the present disclosure is not limited thereto, the second positioning post 5302 also may be a semicylinder, a cylinder, other prisms and the like, correspondingly, the cross section of the second positioning hole 4303 also may be a semicircle, a circle, other prisms and the like. A provided position of the second positioning post 5302 and a provided position of the second positioning hole 4303 also may be interchanged, the number of the second positioning post 5302 and the number of the second positioning hole 4303 also may be appropriately provided according to needs. After the second wafer assembly 300 and the third wafer assembly 400, which are as a whole, and the fourth wafer assembly 500 are mounted and positioned with each other via cooperation between the second positioning posts 5302 and the second positioning holes 4303, the guide flanges 432A and 433A of the third wafer assembly 400 are respectively aligned with the second guide flanges 532A and 533A of the fourth wafer assembly 500, and the guide flanges 432A and 433A of the third wafer assembly 400 and the second guide flanges 532A and 533A of the fourth wafer assembly 500 as a whole are positioned within the datum channels 136 (shown in FIG. 10 and FIG. 11) of the housing 100 with a minimal clearance, and may slide along the datum channels 136.

Two sides of the wafer mold insert 530 of the fourth wafer assembly 500 each are provided with a second latching block 5301, in combination with referring to FIG. 8 and FIG. 9, the second latching blocks 5301 of the fourth wafer assembly 500 may correspondingly insert into the second latching holes 176 which are provided in the two side walls of the housing 100. In addition, an end of a top surface of the wafer mold insert 530 of the fourth wafer assembly 500 close to the front port opening 12 is provided with a protrusion 5304, the protrusion 5304 correspondingly inserts into the snap groove 177 which is provided on the top surface of the housing 100. The protrusion 5304 may interference fit with the snap groove 177.

Considering that a length of the fourth wafer assembly 500 is longer and a spanning distance of the fourth wafer assembly 500 mounted within the housing 100 is also larger, in order to avoid a rear end of the fourth wafer assembly 500 (i.e. an end away from the front port opening 12) sagging or warping left and/or right, an end of the top surface of the wafer mold insert 530 of the fourth wafer assembly 500 away from the front port opening 12 is provided with a second positioning block 5303, the second positioning block 5303 is preferably provided at a middle position along the left-right direction. When the fourth wafer assembly 500 is mounted in place within the housing 100, the second positioning block 5303 cooperates with the second positioning groove 173 which is provided on the top surface of the metal portion 170 of the housing 100. When the second positioning groove 173 is in form dovetail groove, the second positioning block 5303 also is in form of dovetail, but the present disclosure is not limited thereto.

FIG. 12 and FIG. 13 also illustrates the supporting plate 600, a middle part of the supporting plate 600 pushes against a bottom of the second wafer assembly 300, two ends of the supporting plate 600 respectively insert into the inserting grooves 139 (shown in FIG. 10 and FIG. 11) which are provided in the two interior side walls of the housing 100, the supporting plate 600 pushes against a middle location of the second wafer assembly 300 from below, which avoids the middle location of the second wafer assembly 300 collapsing and avoids the second wafer assembly 300 wrapping; on the other hand, the supporting plate 600 has a certain elasticity, thus may provide a certain elasticity for the second wafer assembly 300, the third wafer assembly 400 and the fourth wafer assembly 500 which are assembled together as whole, to compensate assembling tolerances of the second wafer assembly 300, the third wafer assembly 400 and the fourth wafer assembly 500, ensure that the second wafer assembly 300, the third wafer assembly 400 and the fourth wafer assembly 500 tight fit together, and also may absorb forces generated by interference fit between the second wafer assembly 300, the third wafer assembly 400 and the fourth wafer assembly 500.

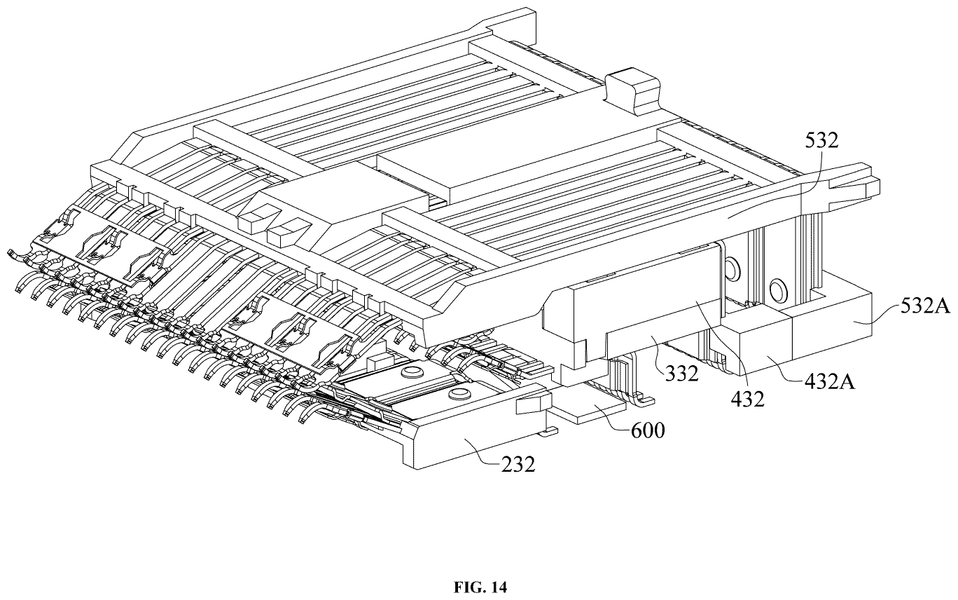

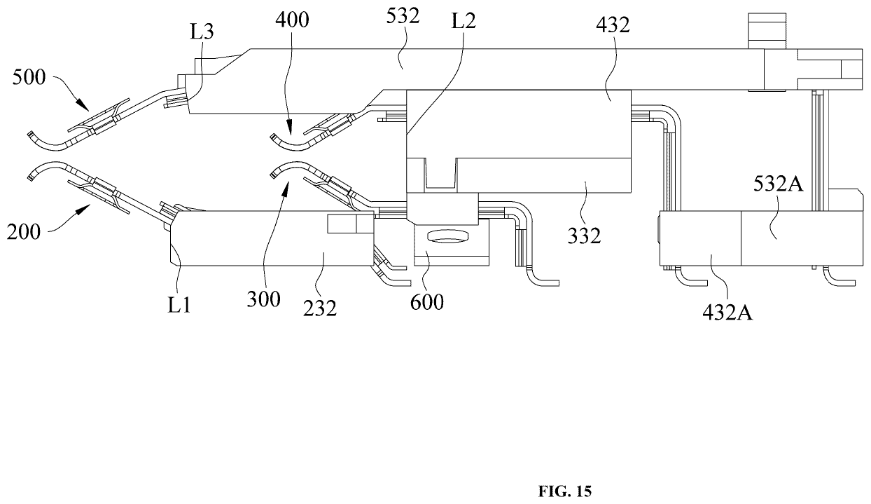

A structure of the first wafer assembly 200, the second wafer assembly 300, the third wafer assembly 400 and the fourth wafer assembly 500 after assembled is shown in FIG. 14 and FIG. 15, where, FIG. 14 and FIG. 15 respectively illustrate a perspective view and a sectional schematic view that the first wafer assembly 200, the second wafer assembly 300, the third wafer assembly 400 and the fourth wafer assembly 500 of the connector according to the yet another embodiment of the present disclosure assembled together. Lead contacts of the terminal row 210 of the first wafer assembly 200 face lead contacts of the terminal row 510 of the fourth wafer assembly 500, lead contacts of the terminal row 310 of the second wafer assembly 300 face lead contacts of the terminal row 410 of the third wafer assembly 400. As shown in FIG. 15, tails of terminals of the first wafer assembly 200, the second wafer assembly 300, the third wafer assembly 400 and the fourth wafer assembly 500 structure all are bent by about 90 degrees to promote coplanarity of the tails of the terminals. In addition, forefront ends of the guide flanges 232 and 233 of the first wafer assembly 200 (close to the front port opening 12) are first edges L1, forefront ends of the interlock flanges 332, 432 and 333, 433 of the second wafer assembly 300 and the third wafer assembly 400 (close to the front port opening 12) are second edge L2, forefront ends of the first guide flanges 532 and 533 of the fourth wafer assembly 500 (close to the front port opening 12) are third edges L3, as shown in FIG. 15, the first edges L1 are closest to the front port opening 12, subsequently the third edges L3 are closer to the front port opening 12, and finally the second edges L2 are close to the front port opening 12. Correspondingly, referring to FIG. 10 and FIG. 11, after the connector 10 is mounted, the stopping edges 1301 and 1331 of the wafer datum channels 130 and 133 engage with the first edges L1 respectively, and are closest to the front port opening 12; the stopping edges 1311 and 1341 of the wafer the datum channels 131 and 134 engage with the second edges L2 respectively, and are most away from the front port opening 12; the stopping edges 1321 and 1351 of the wafer datum channels 132 and 135 engage with the third edges L3 respectively, and are more away from the front port opening 12, and are closer to distance from the stopping edges 1301 and 1331.

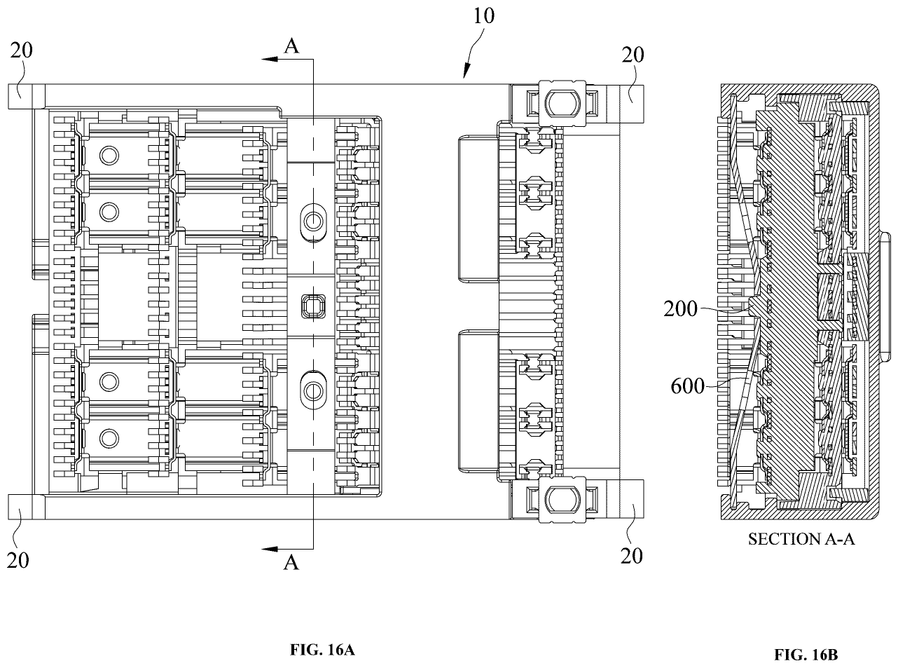

Next description is performed with referring to FIG. 16A and FIG. 16B, where, FIG. 16A illustrates an entire bottom-up schematic view of the connector according to the yet another embodiment of the present disclosure, FIG. 16B illustrates a sectional view of the connector designated A-A of FIG. 16A according to the yet another embodiment of the present disclosure. When the connectors according to the present disclosure need to be soldered and mounted as belly-to-belly, that is, two opposite surfaces of a PCB each need to be soldered with the connector according to the present disclosure, a bottom surface of the connector 10 may be provided with four protruding pieces 20 which are soldered to the PCB, so as to assist in double-surface soldering operation. The sectional view of FIG. 16B illustrates the supporting plate 600 supporting the second wafer assembly 300, the supporting plate 600 pushes against a middle position of a bottom surface of the second wafer assembly 300, the specific mounting provision and function of the supporting plate 600 have been described as above.

The connector according to the yet another embodiment of the present disclosure may be provided with the rigid shields and the flexible shields as the previous various embodiments, to form ground path assemblies for respective wafer assemblies 200, 300, 400, and 500. The connector according to the yet another embodiment of the present disclosure and the connector of the previous various embodiments also each may be provided with a flexible shield 290 as follows.

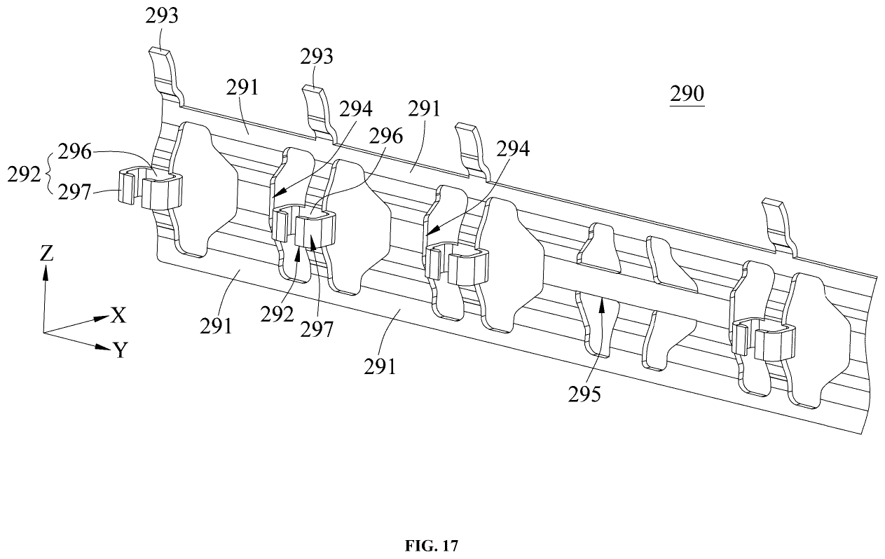

Referring to FIG. 17, FIG. 17 illustrates a schematic view of a flexible shield of another embodiment, the flexible shield 290 makes contact surface regions thereof terminated to surface regions of ground terminals of terminal conductors of each wafer assembly by a clamping manner. Particularly, as shown in FIG. 17, the flexible shield 290 includes multiple transverse beam portions 291, multiple clamping portions 292, multiple abutting portions 293, multiple first shielding portions 294 and multiple second shielding portions 295. The multiple clamping portions 292 of the flexible shield 290 are provided to be spaced apart from each other along the left-right direction Y, and are respectively aligned with the multiple ground terminals of the corresponding wafer assembly. Each clamping portion 292 of the flexible shield 290 has a rib 296 which extends along the up-down direction Z, and a pair of clamping arms 297 which respectively extend from two sides of the rib 296 toward the same direction (i.e. a direction close to corresponding the ground terminal) and curl inwardly. The clamping arms 297 respectively clamp soldering segments of the multiple ground terminals. Every two of the multiple transverse beam portions 291 of the flexible shield 290 are provided between the two adjacent clamping portions 292 and are spaced apart from each other up and down, and a left end and a right end of each transverse beam portion 291 are respectively connected to the two adjacent clamping portions 292. In the embodiment shown in FIG. 17, the number of the multiple clamping portions 292 and the number of the multiple ground terminals are correspondingly equal to each other, but the number of the multiple clamping portions 292 also may be less than the number of the multiple ground terminals, the present disclosure is not limited to a particular number.

Terms such as “top,” “bottom,” “side,” “front,” “back,” “right,” and “left” are not intended to provide an absolute frame of reference. Rather, the terms are relative and are intended to identify certain features in relation to each other, as the orientation of structures described herein can vary. The terms “comprising,” “including,” “having,” and the like are synonymous, are used in an open-ended fashion, and do not exclude additional elements, features, acts, operations, and so forth. Also, the term “or” is used in its inclusive sense, and not in its exclusive sense, so that when used, for example, to connect a list of elements, the term “or” means one, some, or all of the elements in the list.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included. The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely examples of implementations to provide a clear understanding of the principles of the present disclosure. Many variations and modifications can be made to the above-described embodiments without departing substantially from the spirit and principles of the disclosure. In addition, components and features described with respect to one embodiment can be included in another embodiment. All such modifications and variations are intended to be included herein within the scope of this disclosure.

What is claimed is:

1. A connector, comprising:
a housing; and
a wafer assembly comprising a terminal row, a wafer mold insert, and a ground path assembly, wherein:
the terminal row comprises a plurality of terminal conductors;
the ground path assembly comprises a ground shield; and
contact surface regions of the ground shield are terminated to surface regions of ground terminals among the plurality of terminal conductors in the wafer assembly.

2. The connector according to claim 1, wherein shield extension regions of the ground shield extend over signal terminals among the plurality of terminal conductors in the wafer assembly.

3. The connector according to claim 1, wherein:
the ground shield comprises a plurality of segments and bends between the plurality of segments; and
contact surface regions of each of the plurality of segments of the ground shield are terminated to respective surface regions of the ground terminals in the wafer assembly.

4. The connector according to claim 1, wherein:
the ground shield comprises a rigid ground shield;
the ground path assembly further comprises a flexible ground shield;
contact surface regions of the rigid ground shield are terminated to lower surface regions of the ground terminals among the plurality of terminal conductors in the wafer assembly; and
contact surface regions of the flexible ground shield are terminated to upper surface regions of the ground terminals among the plurality of terminal conductors in the wafer assembly.

5. The connector according to claim 1, wherein the ground path assembly comprises a plurality of rigid ground shields and a plurality of flexible ground shields.

6. The connector according to claim 1, wherein the housing comprises a leg latch finger formed in a bottom of the housing and a wafer datum channel and a latch finger formed in a side of the housing.

7. The connector according to claim 1, wherein:
the wafer mold insert comprises an interlock flange;
the housing comprises a latch finger formed in a side of the housing; and
when the wafer assembly is inserted into the housing, the latch finger of the housing snaps into a position of mechanical interference with the interlock flange of the wafer mold insert.

8. The connector according to claim 1, wherein:
the wafer mold insert comprises an interlock leg;
the housing comprises a leg latch finger formed in a bottom of the housing; and
when the wafer assembly is inserted into the housing, the leg latch finger of the housing snaps into a position of mechanical interference with the interlock leg of the wafer mold insert.

9. The connector according to claim 1, wherein:
the wafer mold insert comprises an interlock flange;
the housing comprises a wafer datum channel and a latch finger formed in a side of the housing; and
when the wafer assembly is inserted into the housing, the interlock flange of the wafer mold insert slides into the wafer datum channel of the housing and the latch finger of the housing snaps into a position of mechanical interference with the interlock flange of the wafer mold insert.

10. The connector according to claim 1, further comprising:
a second wafer assembly comprising a second terminal row, a second wafer mold insert, and a second ground path assembly, wherein:
the second wafer mold insert comprises a positioning socket;
the wafer mold insert comprises a positioning post; and
the positioning post of the wafer assembly extends within the positioning socket of the second wafer assembly.

11. The connector according to claim 1, further comprising a second wafer assembly comprising a second terminal row, wherein the ground shield of the wafer assembly extends between the terminal row of the wafer assembly and the second terminal row of the second wafer assembly.

12. The connector according to claim 1, wherein the contact surface regions of the ground shield are laser welded to the surface regions of the ground terminals.

13. A wafer assembly, comprising:
a terminal row;
a wafer mold insert; and
a ground path assembly, wherein:
the terminal row comprises a plurality of terminal conductors;
the ground path assembly comprises a rigid ground shield and a flexible ground shield;
contact surface regions of the rigid ground shield are terminated to first surface regions of ground terminals among the plurality of terminal conductors in the wafer assembly; and
contact surface regions of the flexible ground shield are terminated to second surface regions of the ground terminals in the wafer assembly.

14. The wafer assembly according to claim 13, wherein:
shield extension regions of the rigid ground shield extend over signal terminals among the plurality of terminal conductors in the wafer assembly; and
shield extension regions of the flexible ground shield extend over the signal terminals in the wafer assembly.

15. The wafer assembly according to claim 13, wherein:
the rigid ground shield comprises a plurality of segments and bends between the plurality of segments; and
contact surface regions of each of the plurality of segments of the rigid ground shield are terminated to respective surface regions of the ground terminals in the wafer assembly.

16. The wafer assembly according to claim 13, wherein:
the contact surface regions of the rigid ground shield are terminated to lower surface regions of the ground terminals in the wafer assembly; and
the contact surface regions of the flexible ground shield are terminated to upper surface regions of the ground terminals in the wafer assembly.

17. A connector, comprising:
a housing;
a first wafer assembly comprising a first terminal row, a first wafer mold insert, and a first ground path assembly; and
a second wafer assembly comprising a second terminal row, a second wafer mold insert, and a second ground path assembly, wherein:
the first ground path assembly comprises a first ground shield;
the second ground path assembly comprises a second ground shield;
contact surface regions of the first ground shield are terminated to first surface regions of ground terminals among of the first terminal row in the first wafer assembly; and
contact surface regions of the second ground shield are terminated to second surface regions of ground terminals among of the second terminal row in the second wafer assembly.

18. The connector according to claim 17, wherein:
the first ground path assembly comprises a first plurality of rigid and flexible ground shields; and
the second ground path assembly comprises a second plurality of rigid and flexible ground shields.

19. The connector according to claim 17, wherein:
the first wafer mold insert comprises a first interlock flange;
the second wafer mold insert comprises a second interlock flange;
the housing comprises a first latch finger and a second latch finger formed in a side of the housing; and
when the first wafer assembly and the second wafer assembly are inserted into the housing, the first latch finger of the housing snaps into a position of mechanical interference with the first interlock flange and the second latch finger of the housing snaps into a position of mechanical interference with the second interlock flange.

20. The connector according to claim 17, wherein:
the second wafer mold insert comprises a positioning socket;
the first wafer mold insert comprises a positioning post; and
the positioning post extends within the positioning socket to align the first wafer assembly with the second wafer assembly.

21. The connector according to claim 1, wherein:
the housing comprises a plastic portion and a metal portion,
a front port opening of the connector is formed to the plastic portion.

22. The connector according to claim 21, wherein:
the plastic portion comprises a first snapping portion,
the metal portion comprises a second snapping portion,
the first snapping portion and the second snapping portion engage with each other so that the plastic portion and the metal portion engages with each other.

23. The connector according to claim 21, wherein:
the plastic portion is provided with a connection protruding portion,
the metal portion is provided with a connection hole,
the connection protruding portion is capable of passing through the connection hole and being secured to the connection hole to realize that the plastic portion and the metal portion engage with each other.
